(19) United States
(12) Patent Application Publication
(10) Pub. No.: US 2023/0247465 A1
(43) Pub. Date: Aug. 3, 2023

(54) CROSS LINK INTERFERENCE (CLI) REPORTING BASED ON PHYSICAL UPLINK SHARED CHANNEL (PUSCH) MEASUREMENT IN FULL DUPLEX

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Wanshi CHEN, San Diego, CA (US); Huilin XU, Temecula, CA (US); Ahmed Attia ABOTABL, San Diego, CA (US); Yu ZHANG, San Diego, CA (US); Hwan Joon KWON, San Diego, CA (US); Krishna Kiran MUKKAVILLI, San Diego, CA (US); Tingfang JI, San Diego, CA (US)

(21) Appl. No.: 18/017,003

(22) PCT Filed: Sep. 18, 2020
(86) PCT No.: PCT/CN2020/116139

§ 371 Date: Jan. 19, 2023

(51) Int. Cl. H04W 24/10; H04W 24/08; H04L 5/00; H04W 72/11

(52) U.S. Cl. CPC H04W 24/10; H04W 24/08; H04L 5/0051; H04W 72/11

(57) ABSTRACT

A victim user equipment (UE) may experience cross-link interference (CLI) from a physical uplink shared channel (PUSCH) transmission from an aggressor UE or self-interference (SI) from a PUSCH transmission from a transmitter of the victim UE. The present disclosure provides for configuration of measurement resources and a CLI report for mitigation of CLI. A base station may transmit a configuration of the measurement resources including channel state information interference measurement (CSI-IM) resources and a configuration of a CLI report. The CSI-IM resources match PUSCH symbols or demodulation reference signal (DMRS) symbols of an aggressor UE. The victim UE measures a CLI or a SI on the CSI-IM resources. The victim UE reports the CLI or the SI to the base station according to the configuration of the CLI report. The base station may schedule transmissions to mitigate the CLI or the SI.

### BACKGROUND

### Technical Field

The present disclosure relates generally to communication systems, and more particularly, cross-link interference measurement in full duplex communications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a non-transitory computer-readable medium, and an apparatus for a victim user equipment (UE) are provided. The method may include receiving, from a base station, a configuration of measurement resources including channel state information interference measurement (CSI-IM) resources and a configuration of a cross-link interference (CLI) report. The CSI-IM resources may match physical uplink shared channel (PUSCH) symbols or demodulation reference signal (DMRS) symbols of an aggressor UE. The method may include measuring a CLI or a self-interference (SI) on the CSI-IM resources. The method may include reporting the CLI or SI to the base station according to the configuration of the CLI report.

In some implementations, the CLI or the SI includes a value for each DMRS symbol.

In some implementations, the CLI or the SI includes an average value over DMRS symbols.

In some implementations, the configuration of the measurement resources includes a ratio of an energy per resource element (EPRE) for the PUSCH symbols to EPRE for the DMRS symbols. Measuring the CLI or the SI may include adjusting the CLI based on the ratio. The configuration of the measurement resources may include a plurality of CSI-IM resources and a list of scaling values, each scaling value corresponding to one CSI-IM resource.

In some implementations, receiving the configuration of the measurement resources and CLI reporting includes receiving an indication of a PUSCH bandwidth for a dynamically scheduled PUSCH transmission of the aggressor UE.

In some implementations, the configuration of the measurement resources includes aperiodic CSI-IM resources that match the PUSCH bandwidth.

In some implementations, configuration of the CLI report indicates aperiodic CLI reporting for a sub-band CLI that corresponds to a frequency domain allocation of the PUSCH transmission.

In some implementations, the configuration of the measurement resources includes a periodic or semi-persistent CSI-IM where a frequency domain allocation of the CSI-IM changes from slot to slot. Measuring the CLI or the SI on the CSI-IM resources may include cycling through a sequence of frequency domain allocations. Measuring the CLI or the SI on the CSI-IM resources may include following a deterministic finite state machine having parameters configured by the configuration of the measurement resources. The CSI-IM resource frequency domain allocation may follow predefined rules based on a slot format.

In some implementations, receiving the configuration of the measurement resources comprises receiving a group common downlink control information (DCI) that dynamically schedules a PUSCH transmission for the aggressor UE.

In some implementations, the group common DCI includes a first part that schedules the PUSCH transmission and a second part including one or more blocks, each block indicating a CSI-IM resource set, wherein the victim UE is configured with an index corresponding to one of the one or more blocks.

In some implementations, the method further includes: determining one or more DMRS locations within resources for the PUSCH transmission of aggressor UE based on a PUSCH radio resource control (RRC) configuration of the victim UE using preconfigured rules; and determining a mapping between the one or more DMRS locations and the CSI-IM resources.

In some implementations, the victim UE is configured with CSI-IM resource sets on different symbols that cover different DMRS locations. Determining the mapping may include selecting a CSI-IM resource set that covers the one or more DMRS locations.

In some implementations, the victim UE is configured with a mapping between CSI-IM resource sets and DMRS locations.

In some implementations, receiving the configuration of the measurement resources includes: receiving one or more semi-persistent scheduling (SPS) configurations for the CSI-IM resources that each correspond to a respective configured grant for a PUSCH transmission for the aggressor UE; and receiving a group common DCI that activates one of the SPS DL configuration s and the corresponding UL configured grant.

In some implementations, receiving the configuration of the measurement resources includes receiving a configuration of semi-persistent CSI-IM resources. A periodicity and an offset of the semi-persistent CSI-IM resources may match a configured grant of the aggressor UE. The semi-persistent CSI-IM resources may be activated by a media access control (MAC) control element (CE). The semi-persistent CSI-IM resources may be activated by a common DCI that includes one or more blocks, each block indicating a CSI-IM resource set to activate. The victim UE may be configured with an index corresponding to one of the one or more blocks.

In some implementations, reporting the CLI to the base station includes determining to drop a report when a value of the CLI is less than a configured threshold.

In some implementations, reporting the CLI to the base station includes reporting the CLI regardless of whether a PUSCH transmission occurs on the CSI-IM resource.

In some implementations, receiving the configuration of the measurement resources includes: receiving one or more semi-persistent scheduling (SPS) configurations for the CSI-IM resources that each correspond to a respective configured grant for a PUSCH transmission for the aggressor UE; receiving a configuration of semi-persistent CSI-IM resources, wherein a periodicity and an offset of the semi-persistent CSI-IM resources match a configured grant of the aggressor UE; and receiving a group common DCI that activates one of the SPS DL configurations and the CLI reporting based on the configuration of semi-persistent CSI-IM resources.

In some implementations, receiving the configuration of the measurement resources includes receiving a configuration of semi-persistent CSI-IM resources and a transmission configuration indicator (TCI) state for CSI-IM indicating a quasi-co-location (QCL) spatial receive parameter.

In some implementations, the configuration of the measurement resources indicates a TCI state associated with each semi-persistent CSI-IM resource. Measuring the CLI may include using the TCI state associated with each semi-persistent CSI-IM resource for each instance of the semi-persistent CSI-IM resource.

In some implementations, the configuration of the measurement resources indicates a list of TCI states associated with the semi-persistent CSI-IM resources. Measuring the CLI may include cycling over the list of TCI states for multiple instances of the semi-persistent CSI-IM resources.

In some implementations, the configuration of the measurement resources indicates a sequence of lists of TCI states associated with the semi-persistent CSI-IM resources, wherein measuring the CLI comprises cycling over the lists of TCI states for multiple instances of the semi-persistent CSI-IM resources. The victim UE may use one of the lists of TCI states for each instance of the semi-persistent CSI-IM resources.

In some implementations, reporting the CLI to the base station includes determining to drop a report when a value of the CLI is less than a configured threshold.

In some implementations, the value of the CLI is an average of CLI values for the same QCL spatial receive parameter and a report includes pairs of a CLI value and a QCL spatial receive parameter.

In some implementations, the value of the CLI is an average of CLI values over all QCL spatial receive parameters.

In some implementations, the method further includes transmitting an indication of whether the victim UE supports one or more of: CLI or SI measurement in CSI-IM resources; a common DCI for PUSCH configuration; a common DCI for triggering CLI measurement and reporting; explicit or implicit indication of CSI-IM resources in common DCI; a common DCI for triggering configured grants in uplink; a common DCI for triggering SPS for downlink; a common DCI for triggering semi-persistent CSI-IM resources; a common DCI for triggering semi-persistent CLI reporting; QCL for CLI measurement; or different QCL for semi-persistent CSI-IM measurement occasions.

In another aspect, a method, a non-transitory computer-readable medium, and an apparatus for a base station are provided. The method may include transmitting, to an aggressor UE, a configuration of a PUSCH transmission including PUSCH symbols and DMRS symbols. The method may include transmitting, to a victim UE, a configuration of measurement resources including CSI-IM resources and a configuration of a CLI report. The CSI-IM resources match the PUSCH symbols or the DMRS symbols of the aggressor UE. The method may include receiving a measurement of a CLI or a SI based on the configuration of the measurement resources.

In some implementations, the measurement of the CLI or the SI includes a value for each DMRS symbol.

In some implementations, the measurement of the CLI or the SI includes an average value over DMRS symbols.

In some implementations, the configuration of the measurement resources includes a ratio of an EPRE for the PUSCH symbols to EPRE for the DMRS symbols.

In some implementations, the configuration of the measurement resources includes a plurality of CSI-IM resources and a list of scaling values, each scaling value corresponding to one CSI-IM resource.

In some implementations, the configuration of the measurement resources includes an indication of a PUSCH bandwidth for a dynamically scheduled PUSCH transmission of the aggressor UE.

In some implementations, the configuration of the measurement resources includes aperiodic CSI-IM resources that match the PUSCH bandwidth.

In some implementations, the configuration of the CLI report indicates aperiodic CLI reporting for a sub-band CLI that corresponds to a frequency domain allocation of the PUSCH transmission.

In some implementations, the configuration of the measurement resources includes a periodic or a semi-persistent CSI-IM where a frequency domain allocation of the CSI-IM resources changes from slot to slot.

In some implementations, the measurement of the CLI or the SI cycles through a sequence of frequency domain allocations.

In some implementations, the measurement of the CLI or the SI follows a deterministic finite state machine having parameters configured by the configuration of the measurement resources.

In some implementations, wherein the CSI-IM resource frequency domain allocation follows predefined rules based on a slot format.

In some implementations, the configuration of the measurement resources includes a group common DCI that dynamically schedules a PUSCH transmission for the aggressor UE.

In some implementations, the group common DCI includes a first part that schedules the PUSCH transmission and a second part including one or more blocks, each block indicating a CSI-IM resource set. The victim UE may be configured with an index corresponding to one of the one or more blocks.

In some implementations, the configuration of the measurement resources includes: one or more SPS DL configurations for the CSI-IM resources that each correspond to a respective configured grant for a PUSCH transmission for the aggressor UE; and a group common DCI that activates one of the SPS DL configurations and the corresponding UL configured grant.

In some implementations, the configuration of the measurement resources includes a configuration of semi-persistent CSI-IM resources. A periodicity and an offset of the semi-persistent CSI-IM resources may match a configured grant of the aggressor UE.

In some implementations, the semi-persistent CSI-IM resources are activated by a MAC-CE.

In some implementations, the semi-persistent CSI-IM resources are activated by a group common DCI that includes one or more blocks, each block indicating a CSI-IM resource set to activate, wherein the victim UE is configured with an index corresponding to one of the one or more blocks.

In some implementations, receiving the measurement of the CLI or the SI based on the configuration of the measurement resources includes filtering the CLI or the SI based on whether the aggressor UE transmitted the PUSCH transmission.

In some implementations, the configuration of the measurement resources includes: one or more SPS configurations for the CSI-IM resources that each correspond to a respective configured grant for a PUSCH transmission for the aggressor UE; a configuration of semi-persistent CSI-IM resources, where a periodicity and an offset of the semi-persistent CSI-IM resources match a configured grant of the aggressor UE; and a group common DCI that activates one of the SPS DL configurations and the CLI reporting based on the configuration of semi-persistent CSI-IM resources.

In some implementations, the configuration of the measurement resources includes a configuration of semi-persistent CSI-IM resources and a TCI state for CSI-IM indicating a QCL spatial receive parameter.

In some implementations, the configuration of the measurement resources indicates a TCI state associated with each semi-persistent CSI-IM resource.

In some implementations, the configuration of the measurement resources indicates a list of TCI states associated with the semi-persistent CSI-IM resources.

In some implementations, the configuration of the measurement resources indicates a sequence of lists of TCI states associated with the semi-persistent CSI-IM resources.

In some implementations, the measurement of the CLI is an average of CLI values for the same QCL spatial receive parameter and a report includes pairs of a CLI value and a QCL spatial receive parameter.

In some implementations, the measurement of the CLI is an average of CLI values over all QCL spatial receive parameters.

In some implementations, the method may further include receiving an indication of whether the victim UE supports one or more of: CLI or SI measurement in CSI-IM resources; a common DCI for PUSCH configuration; a common DCI for triggering CLI measurement and reporting; explicit or implicit indication of CSI-IM resources in common DCI; a common DCI for triggering configured grants in uplink; a common DCI for triggering SPS for downlink; a common DCI for triggering semi-persistent CSI-IM resources; a common DCI for triggering semi-persistent CLI reporting; QCL for CLI measurement; or different QCL for semi-persistent CSI-IM measurement occasions.

In an aspect of the disclosure, a method, a non-transitory computer-readable medium, and an apparatus for an aggressor UE are provided. The method may include receiving a group common DCI. The group common DCI may include a first part that schedules a PUSCH transmission for the aggressor UE and a second part including one or more blocks, each block indicating a CSI-IM resource set for one or more victim UEs. The method may include determining a PUSCH configuration based on the group common DCI. The method may include transmitting the PUSCH transmission based on the PUSCH configuration.

In some implementations, the group common DCI dynamically schedules the PUSCH transmission for the aggressor UE.

In some implementations, the group common DCI activates a configured grant for the aggressor UE and a corresponding SPS DL configuration for the one or more victim UEs.

In some implementations, the group common DCI activates a configured grant for the aggressor UE and a corresponding configuration of semi-persistent CSI-IM resources for the one or more victim UEs.

In some implementations, the method further includes transmitting an indication that the aggressor UE supports the group common DCI for triggering configured grants in uplink.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with certain aspects of the present description.

FIG. 2A is a diagram illustrating an example of a first frame, in accordance with certain aspects of the present description.

FIG. 2B is a diagram illustrating an example of DL channels within a subframe, in accordance with certain aspects of the present description.

FIG. 2C is a diagram illustrating an example of a second frame, in accordance with certain aspects of the present description.

FIG. 2D is a diagram illustrating an example of UL channels within a subframe, in accordance with certain aspects of the present description.

FIG. 3 is a diagram illustrating an example of a base station and user equipment (UE) in an access network, in accordance with certain aspects of the present description.

FIGS. 4A, 4B, and 4C illustrate exemplary modes of full-duplex communication.

FIGS. 5A and 5B illustrate examples of resources that are in-band full duplex (IBFD).

FIG. 5C illustrates an example of resources for sub-band full-duplex communication.

FIG. 6 is an example of time and frequency resources including full-duplex resources.

FIGS. 7A and 7B illustrate examples of intra-cell and inter-cell interference.

FIG. 8 illustrates example resources for a first UE and a second UE.

FIG. 9 illustrates an example group common downlink control information (DCI).

FIG. 10 is a message diagram illustrating example messages for cross-link interference (CLI) reporting with dynamic scheduling.

FIG. 11 is a message diagram illustrating example messages for CLI reporting with semi-persistent scheduling.

FIG. 12 is a conceptual data flow diagram illustrating the data flow between different means/components in an example BS.

FIG. 13 is a conceptual data flow diagram illustrating the data flow between different means/components in an example UE.

FIG. 14 is a flowchart of an example method of CLI reporting for a UE.

FIG. 15 is a flowchart of an example method of configuring a victim UE for CLI reporting based on a transmission of an aggressor UE.

FIG. 16 is a flowchart of an example method of transmitting a physical uplink shared channel (PUSCH) from an aggressor UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G NR, the concepts described herein may be applicable to other similar areas, such as LTE, LTE-A, CDMA, GSM, and other wireless technologies.

Full duplex communication may allow a wireless communication device to transmit and receive at the same time. In-band full duplex (IBFD) may refer to transmission and reception on the same time and frequency resource. The uplink (UL) and the downlink (DL) may share the same IBFD time and frequency resource, which may include fully overlapping resources or partially overlapping resources. Sub-band frequency division duplexing (SBFD) may refer to transmission and reception at the same time on different frequency resources. The DL resource may be separated from the UL resource in the frequency domain. In an access network, a base station and/or a user equipment (UE) may be capable of either IBFD or SBFD.

The presence of full duplex devices in an access network may result in configurations with different types of interference experienced by a UE. Inter-cell interference may include interference from other gNBs and exist without the presence of full duplex devices. Channel state information (CSI) measurements may be used to measure inter-cell interference. Inter-cell cross-link interference (CLI) may occur between UEs in adjacent cells. Intra-cell CLI may occur between UEs in the same cell. For example, an uplink transmission from an aggressor UE may interfere with a downlink reception of a victim UE. In the case of a full-duplex UE, self-interference (SI) may be considered a special case of intra-cell CLI, where the transmitter of the UE acts as an aggressor UE that interferes with a downlink reception by the receiver of the UE.

In an aspect, the present disclosure provides for measurement and reporting of CLI and/or SI based on a PUSCH transmission of the aggressor UE. The PUSCH transmission may include PUSCH symbols and demodulation reference signal (DMRS) symbols. Measurement of the PUSCH transmission may provide more accurate measurement of CLI than other uplink reference signals (e.g., sounding reference signal (SRS)) because the CLI may be affected by power control for the PUSCH transmission. The power for the DMRS symbols may be based on the PUSCH power control. The DMRS symbols, however, may be transmitted with a known sequence that may be used for measurements. Accordingly, a CLI measurement based on the DMRS symbols of the PUSCH transmission may provide an accurate representation of CLI experienced due to the PUSCH transmission. In an aspect, the present disclosure provides for configuration of the victim UE based on the PUSCH configuration of the aggressor UE such that the victim UE is configured with channel state information interference measurement (CSI-IM) resources that match the DMRS symbols of the PUSCH transmission. The victim UE may use the CSI-IM resources to measure the CLI from the PUSCH transmission and generate a CLI report. At least in the case of intra-cell CLI, the base station may be able to schedule the aggressor UE and/or the victim UE to mitigate the effects of CLI.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

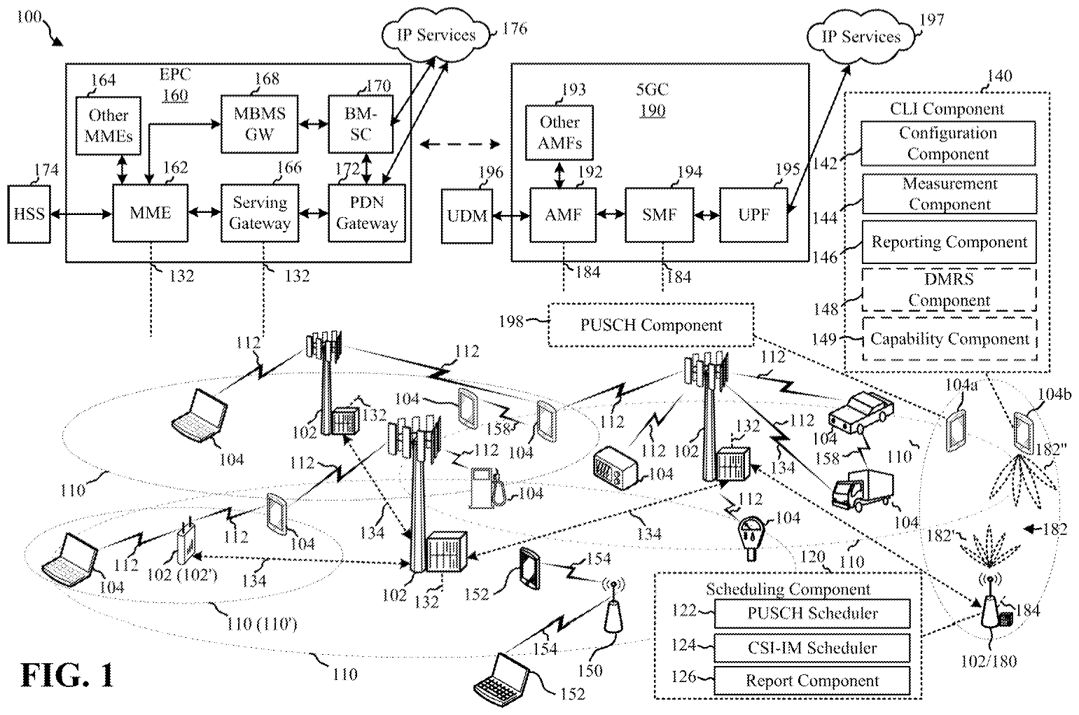

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network (e.g., a 5G Core (5GC) 190). The base stations 102 may include macrocells (high power cellular base station) and/or small cells (low power cellular base station). The macrocells include base stations. The small cells include femtocells, picocells, and microcells.

One or more of the UEs 104 (e.g., UE 104b) may include a CLI component 140 that measures a CLI and/or SI based on a configuration and reports the CLI/SI to the base station 102. The CLI component 140 may include a configuration component 142 configured to receive a configuration of measurement resources including channel state information interference measurement (CSI-IM) resources that match physical uplink shared channel (PUSCH) symbols or demodulation reference signal (DMRS) symbols of an aggressor UE (e.g., UE 104a). CLI component 140 may include a measurement component 144 configured to measure a cross-link interference (CLI) or a self-interference (SI) on the CSI-IM resources. The CLI component 140 may include a reporting component 146 configured to report the CLI or SI to the base station. In some implementations, the CLI component 140 may optionally include a DMRS component configured to map DMRS locations to CSI-IM resources. In some implementations, the CLI component 140 may optionally include a capability component 149 configured to transmit an indication of one or more capabilities of the UE 104 related to CLI measurement and reporting.

One or more of the UEs 104 (e.g., UE 104a) may include a PUSCH component 198 that transmits a PUSCH transmission in response to a group common downlink control information (DCI) that indicates CSI-IM resources for the victim UE (e.g., UE 104b). The PUSCH component 198 may receive the group common DCI (e.g., from a base station). The group common DCI may include a first part that schedules a PUSCH transmission for the aggressor UE and a second part including one or more blocks, each block indicating a CSI-IM resource set for one or more victim UEs. The PUSCH component 198 may determine a PUSCH configuration based on the group common DCI. The PUSCH component 198 may transmit the PUSCH transmission based on the PUSCH configuration. In some implementations, a full-duplex UE may include both the CLI component 140 and the PUSCH component 198. The full-duplex UE may measure SI from a PUSCH transmission on the configured CSI-IM resource set, and report the SI to the base station 102.

In an aspect, one or more of the base stations 102 may include a scheduling component 120 that performs the actions of the base station as described herein (e.g., scheduling the scheduling victim UEs to measure CLI and aggressor UEs to transmit PUSCH transmissions). For example, the scheduling component 120 may include: a PUSCH scheduler 122 configured to transmit a configuration of a PUSCH transmission including PUSCH symbols and demodulation reference signal (DMRS) symbols to an aggressor UE. The scheduling component 120 may include a CSI-IM scheduler configured to transmit, to a victim UE, a configuration of measurement resources including channel state information interference measurement (CSI-IM) resources that match the PUSCH symbols or the DMRS symbols of the PUSCH transmission. The scheduling component 120 may include a report component 126 configured to receive a measurement of CLI or SI based on the configuration of measurement resources.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The backhaul links 132 may be wired or wireless. The base stations 102 configured for 5G NR (collectively referred to as Next Generation RAN (NG-RAN)) may interface with 5GC 190 through backhaul links 184. The backhaul links 184 may be wired or wireless. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 112 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 112 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and a physical sidelink feedback channel (PSFCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

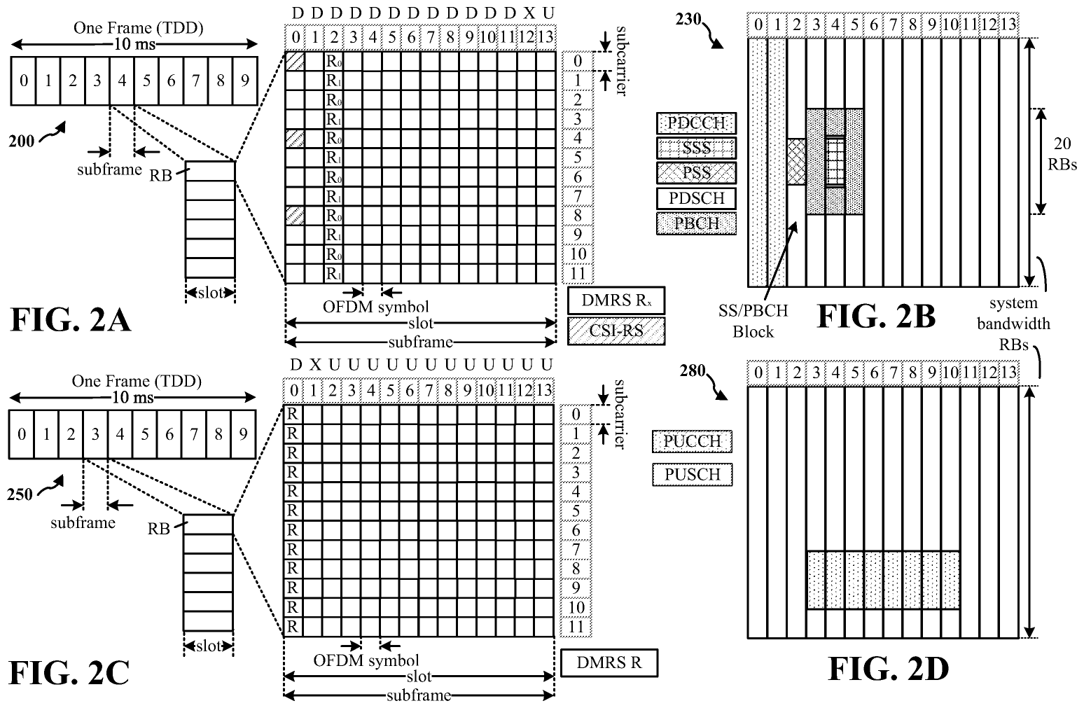

FIGS. 2A-2D are resource diagrams illustrating example frame structures and channels that may be used for uplink, downlink, and sidelink transmissions to a UE 104 including a CLI component 140. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

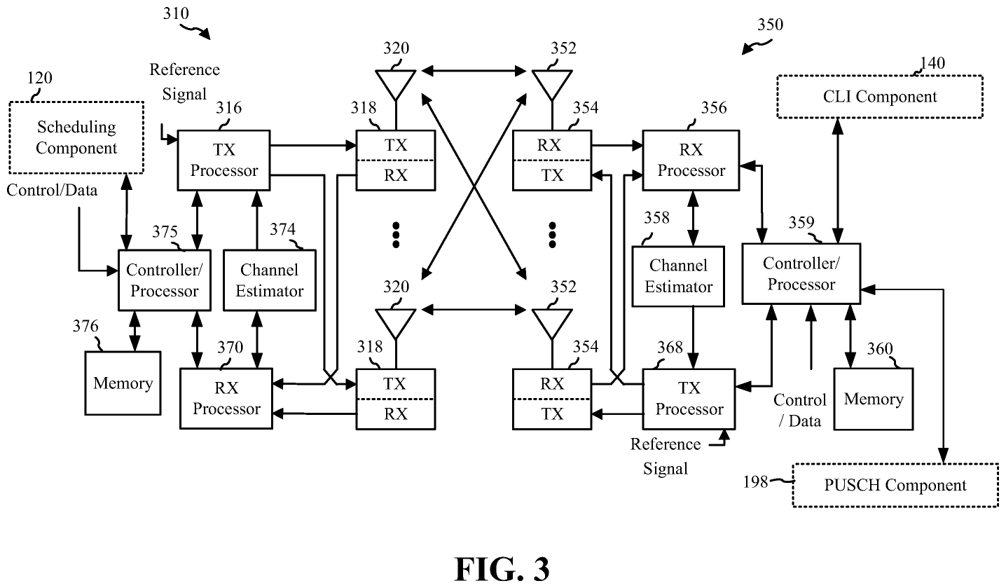

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160 or 5GC 190. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the CLI component 140 and/or the PUSCH component 198 of FIG. 1.

At least one of the TX processor 316, the RX processor 370, and the controller/processor 375 may be configured to perform aspects in connection with the scheduling component 120 of FIG. 1.

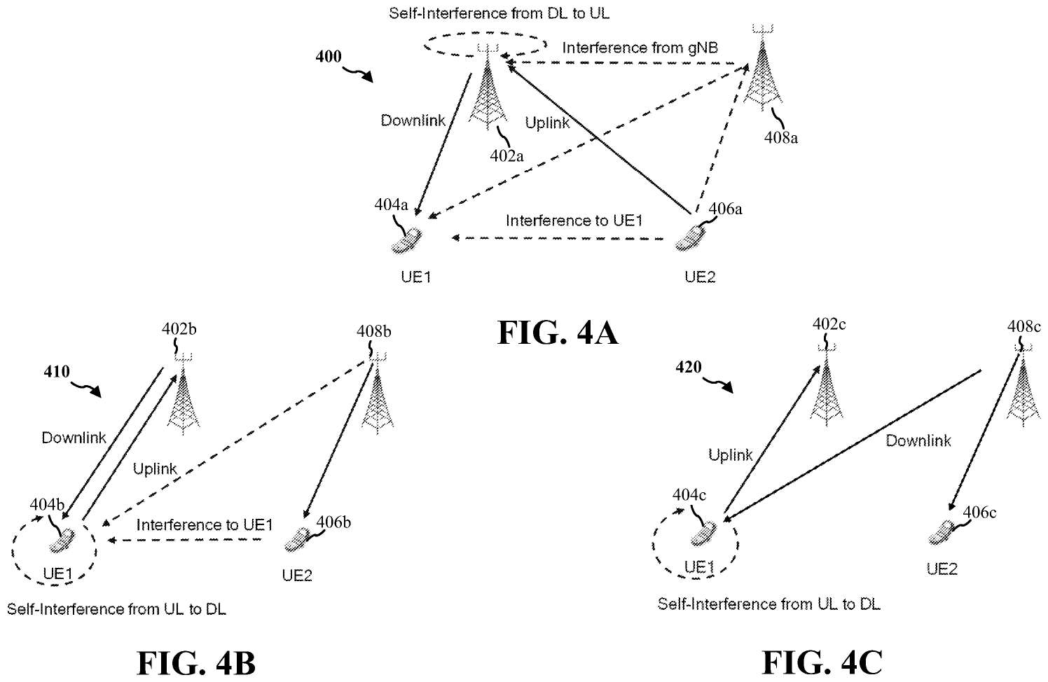

FIGS. 4A-4C illustrate various modes of full-duplex communication. Full-duplex communication supports transmission and reception of information over a same frequency band in manner that overlap in time. In this manner, spectral efficiency may be improved with respect to the spectral efficiency of half-duplex communication, which supports transmission or reception of information in one direction at a time without overlapping uplink and downlink communication. Due to the simultaneous Tx/Rx nature of full-duplex communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication, or even lead to a loss of information.

FIG. 4A shows a first example of full-duplex communication 400 in which a first base station 402a is in full duplex communication with a first UE 404a and a second UE 406a. The first base station 402a is a full-duplex base station, whereas the first UE 404a and the second UE 406a may be configured as either a half-duplex UE or a full-duplex UE. The second UE 406a may transmit a first uplink signal to the first base station 402a as well as to other base stations, such as a second base station 408a in proximity to the second UE 406a. The first base station 402a transmits a downlink signal to the first UE 404a concurrently with receiving the uplink signal from the second UE 406a. The base station 402a may experience self-interference at the receiving antenna that is receiving the uplink signal from UE 406a receiving some of the downlink signal being transmitted to the UE 404a. The base station 402a may experience additional interference due to signals from the second base station 408a. Interference may also occur at the first UE 404a based on signals from the second base station 408a as well as from uplink signals from the second UE 406a.

FIG. 4B shows a second example of full-duplex communication 410 in which a first base station 402b is in full-duplex communication with a first UE 404b. In this example, the first base station 402b is a full-duplex base station and the first UE 404b is a full-duplex UE. The first base station 402b and the UE 404b that can concurrently receive and transmit communication that overlaps in time in a same frequency band. The base station and the UE may each experience self-interference, in which a transmitted signal from the device is leaked to a receiver at the same device. The first UE 404b may experience additional interference based on one or more signals emitted from a second UE 406b and/or a second base station 408b in proximity to the first UE 404b.

FIG. 4C shows a third example of full-duplex communication 420 in which a first UE 404c is a full-duplex UE in communication with a first base station 402c and a second base station 408c. The first base station 402c and the second base station 408c may serve as multiple transmission and reception points (multi-TRPs) for UL and DL communication with the UE 404c. The second base station 408c may be in communication with a second UE 406c. In FIG. 4C, the first UE 404c may concurrently transmit an uplink signal to the first base station 402c while receiving a downlink signal from the second base station 408c. The first UE 404c may experience self-interference as a result of the first signal and the second signal being communicated simultaneously, e.g., the uplink signal may leak to, e.g., be received by, the UE's receiver. The first UE 404c may experience additional interference from the second UE 406c.

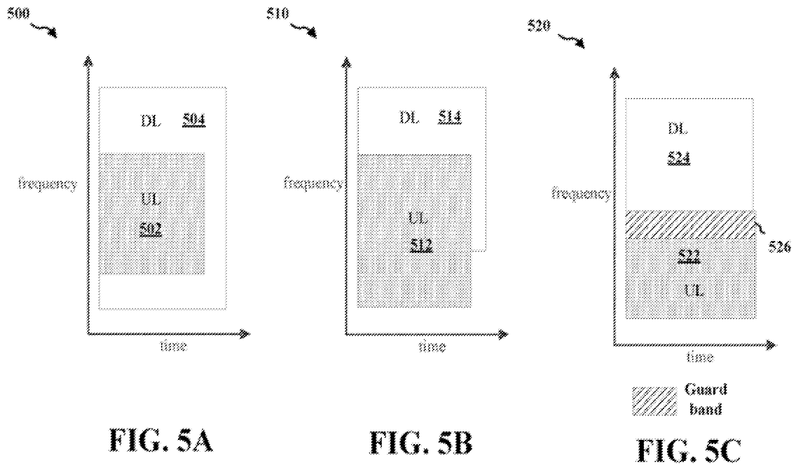

FIGS. 5A-5B illustrate a first example 500 and a second example 510 of in-band full duplex (IBFD) resources. FIG. 5C illustrates an example 520 of sub-band full-duplex resources. In IBFD, signals may be transmitted and received in overlapping times and overlapping in frequency. As shown in the first example 500, a time and a frequency allocation of a UL resources 502 may fully overlap with a time and a frequency allocation of DL resources 504. In the second example 510, a time and a frequency allocation of UL resources 512 may partially overlap with a time and a frequency of allocation of DL resources 514.

IBFD is in contrast to sub-band FD (SBFD), where uplink and downlink resources may overlap in time using different frequencies, as shown in FIG. 5C. As shown in FIG. 5C, the UL resources 522 are separated from the DL resources 524 by a guard band 526. The guard band may be frequency resources, or a gap in frequency resources, provided between the UL resources 522 and the DL resources 524. Separating the UL frequency resources and the DL frequency resources with a guard band may help to reduce self-interference. UL resources and a DL resources that are immediately adjacent to each other correspond to a guard band width of 0. As an output signal, e.g., from a UE transmitter may extends outside the UL resources, the guard band may reduce interference experienced by the UE. Sub-band FD may also be referred to as “flexible duplex”.

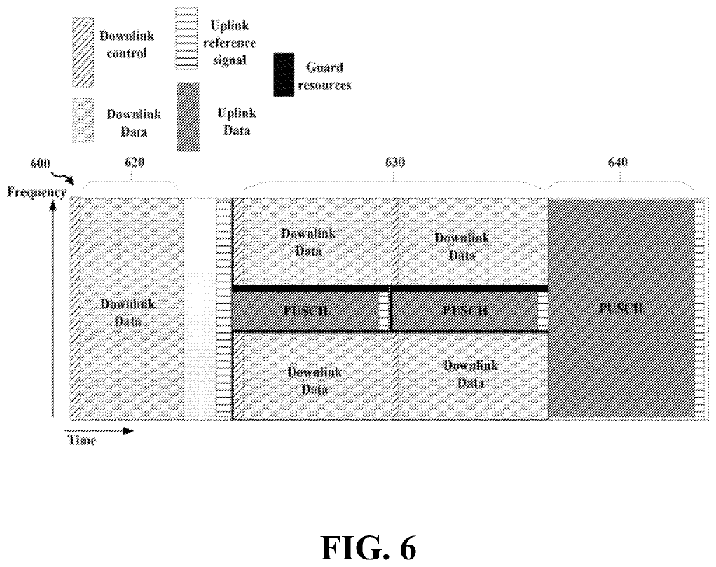

FIG. 6 illustrates an example set of time and frequency resources 600 that include both half duplex and full duplex periods. For example, the period of time 620 includes half duplex resources for downlink data. The period of time 620 includes sub-band full-duplex resources for uplink transmissions (e.g., PUSCH) and downlink reception (e.g., downlink data). The period of time 640 includes half duplex resources for uplink data.

A slot format may be referred to as a “D+U” slot when the slot has a frequency band that is used for both uplink and downlink transmissions. The downlink and uplink transmissions may occur in overlapping frequency resources, such as shown in FIGS. 5A and 5B (e.g., in-band full duplex resources) or may occur in adjacent or slightly separated frequency resources, such as shown in FIG. 5C (e.g., sub-band full duplex resources). In a particular D+U symbol, a half-duplex device may either transmit in the uplink band or receive in the downlink band. In a particular D+U symbol, a full-duplex device may transmit in the uplink band and receive in the downlink band, e.g., in the same symbol or in the same slot. A D+U slot may include downlink only symbols, uplink only symbols, and full-duplex symbols. For example, in FIG. 6, the period of time 620 may extend for one or more symbols (e.g., downlink only symbols), the period of time 640 may extend for one or more symbols (e.g., uplink only symbols), and the period 630 may extend for one or more symbols (e.g., full-duplex symbols or D+U symbols).

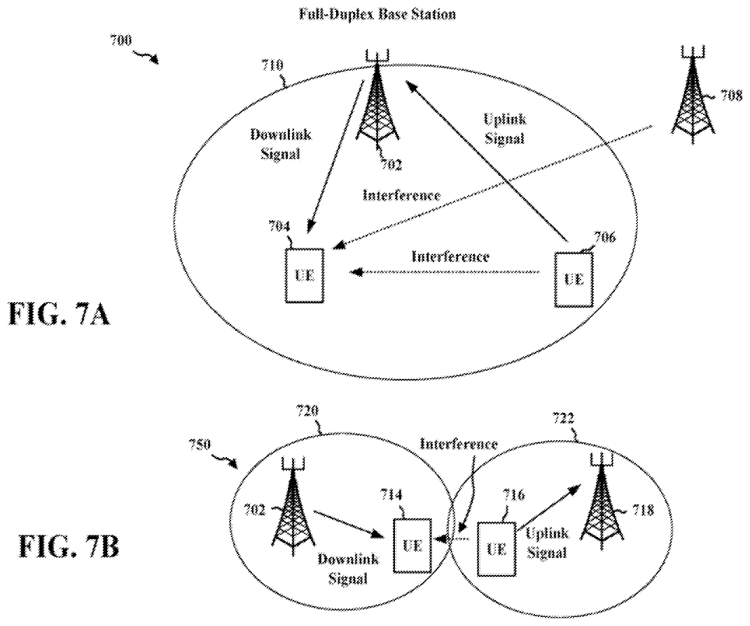

FIG. 7A illustrates an example communication system 700 with a full-duplex base station 702 that includes intra-cell cross-link interference (CLI) caused to UE 704 by UE 706 that are located within the same cell coverage 710 as well as inter-cell interference from a base station 708 outside of the cell coverage 710. FIG. 7B illustrates an example communication system 750 showing inter-cell cross-link interference from UE 716 that interferences with downlink reception for UE 714. The UE 714 is in the cell coverage 720 of base station 712, and the UE 716 is in the cell coverage 722 of the base station 718. Although not shown, a full-duplex UE may cause self-interference to its own downlink reception.

In sub-band full duplex (SBFD), a base station may configure a downlink transmission to a UE in frequency domain resources that are adjacent to frequency domain resources for uplink transmissions for another UE. For example, in FIG. 7A, the frequency resources for the downlink transmission to the UE 704 may be adjacent to the frequency resources for the uplink transmission from the UE 706.

CLI/SI measurements may be used by the base station in making scheduling decisions for future slots. In general, the power control and Tx power for SRS are different from PUSCH. CLI/SI measured based on SRS may not accurately represent CLI/SI from PUSCH. For example, PUSCH transmission power may be represented by the following expression.

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ]$$

For comparison, SRS power may be represented by the following expression.

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} [ dBm ]$$

The SRS power control adjustment h(.)=f(.) if srs-PowerControlAdjustmentStates indicates a same power state for both SRS and PUSCH, but may otherwise vary. Additionally, the offset Δ_{TF,b,f,c}(i) may only apply to the PUSCH. Therefore, there may be differences in the power of PUSCH and SRS that a CLI measurement based on SRS differs from CLI caused by PUSCH. Accordingly, in an aspect, the present disclosure provides for CLI and SI measurements based on a PUSCH transmission, which may include DMRS symbols and PUSCH symbols.

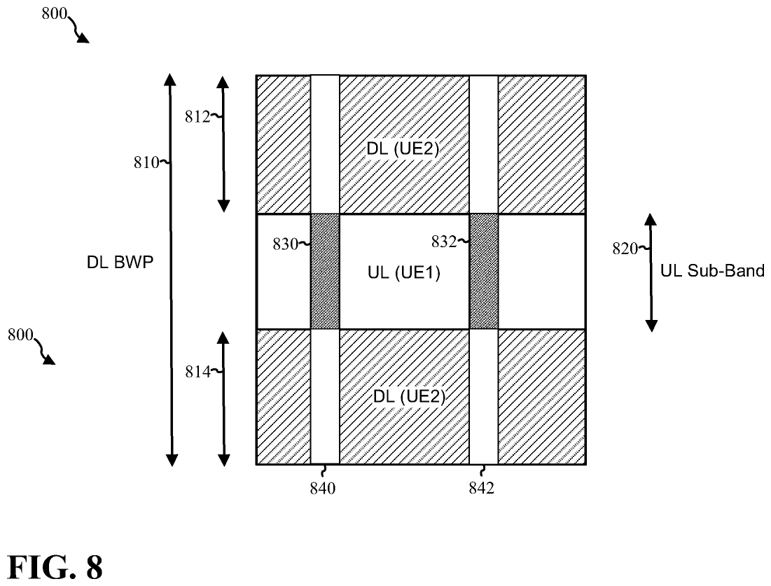

FIG. 8 is a diagram illustrating example resources 800 for a first UE (UE1) and a second UE (UE2). The first UE may transmit a PUSCH transmission on a UL sub-band 820 and may be considered an aggressor UE. The second UE (UE2) may receive a downlink transmission such as a PDSCH on a DL BWP 810, which may include one or more DL sub-bands 812, 814. The second UE may be considered a victim UE.

In an aspect, the base station may configure the victim UE with CSI-IM resources on the same symbols where an aggressor UE is configured with PUSCH. The CSI-IM resources of the victim UE can be configured to match the PUSCH DMRS pattern of the aggressor UE. For example, the first UE may be configured with a DMRS pattern that includes DMRS on symbols 830 and 832 within the UL sub-band 820. The second UE may be configured with CSI-IM resources 840 and 842 that correspond to the symbols 830 and 832. Accordingly, the second UE may measure the CLI based on the DMRS transmitted by the first UE. In some implementations, a single full duplex UE may be configured with both the PUSCH DMRS pattern and the CSI-IM resources for performing SI measurements.

The configuration of the PUSCH DMRS pattern and the CSI-IM resources may depend on a type of scheduling. For dynamic grant-based UL, given that PUSCH allocation is flexible, the base station can configure the victim UE with aperiodic CSI-IM and aperiodic CLI reporting. For configured-grant UL, the base station may configure the victim UE with semi-persistent or periodic CSI-IM resources to match the periodic transmission of the aggressor UE.

A victim UE can be configured with multiple CSI-IM resources to match PUSCH DMRS symbols from one or more aggressors. There may be multiple options for reporting CLI/SI when the UE is configured with multiple CSI-IM resources for CLI/SI. In a first option, the victim UE may report a CLI/SI value for each DMRS symbol. This first option may provide all available information, but may consume uplink bandwidth for reporting. In a second option, the victim UE may report an average CLI/SI value over the configured DMRS symbols. This option may provide sufficient information for scheduling, while reducing the size of the CLI/SI report compared to the first option.

In an aspect, PUSCH energy per resource element (EPRE) and DMRS EPRE may be different. Interference measurement based on DMRS may be adjusted to account for the difference between PUSCH EPRE and DMRS EPRE. When the base station configures the victim UE to measure CLI based on a PUSCH DMRS of the aggressor UE, the base station may inform the victim UE about the ratio between PUSCH EPRE and DMRS EPRE. For example, the base station may indicate in a CLI report configuration that scaling is needed to account for PUSCH EPRE and DMRS EPRE. As another example, if the victim UE is configured to measure average CLI over CSI-IM resources corresponding to DMRS symbols from multiple aggressors, the CLI report configuration may include a list of scaling values, each of which corresponds to one CSI-IM resource in the resource set. That is, the victim UE may apply a different scaling value to each CSI-IM resource to account for the different ratios of PUSCH EPRE to DMRS EPRE for different aggressor UEs. The following table may be used to adjust CLI/SI measurement of EPRE.

TABLE 6.2.2-1
The ratio of PUSCH EPRE to DM-RS EPRE

| Number of DM-RS | DM-RS | DM-RS | |
|---|---|---|---|
| CDM groups | configuration | configuration | |
| without data | type 1 | type 2 | |
| 1 | 0 dB | 0 | dB |
| 2 | −3 dB | −3 | dB |
| 3 | — | −4.77 | dB |

For dynamic grant-based UL scheduling, the PUSCH frequency allocation can change from slot to slot. In an aspect, the base station may configure the victim UE to measure CLI based on the PUSCH bandwidth. For example, the base station may configure the victim UE with aperiodic CSI-IM resources to match the PUSCH bandwidth. As another example, the base station may configure the victim UE with aperiodic CLI reporting where the victim UE measures a sub-band CLI that corresponds to PUSCH frequency allocation of the aggressor UE. As another example, the base station may configure periodic or semi-persistent CSI-IM resources, where a frequency allocation of CSI-IM resources changes from slot to slot. For instance, the base station may transmit an RRC configuration for CSI-IM resources including a sequence of frequency domain allocations. The victim UE may cycle over the sequence of frequency domain allocations with each slot. As another example of changing CSI-IM resources, the CSI-IM resource frequency domain allocation may follow a deterministic finite state machine. The base station may transmit an RRC configuration including parameters of the finite state machine. For example, the victim UE may measure a wideband CSI in a first state and measure a narrowband CSI in a second state. The UE may change states based on whether the measured CSI satisfies a threshold. As another example of changing CSI-IM resources, the CSI-IM resource frequency domain allocation may follow predefined rules based on the slot format. For example, each slot format may be associated with a mapping from a slot number to frequency domain resources.

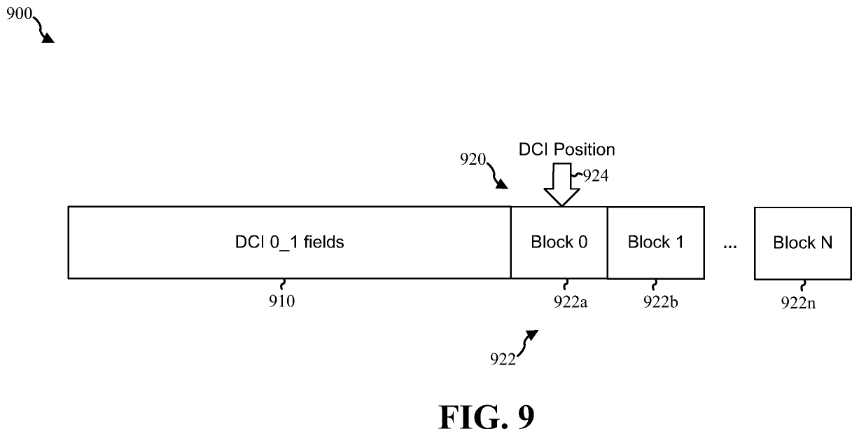

In an aspect, CLI measurements based on a PUSCH transmission may involve scheduling both the aggressor UE and the victim UE. In some implementations, a base station may send a common that DCI triggers a PUSCH transmission from an aggressor UE and triggers CLI measurement and reporting from one or more victim UEs. FIG. 9 illustrates an example group common DCI 900. The group common DCI 900 may include a first part 910 that schedules the PUSCH transmission and a second part 920 including one or more blocks 922 (e.g., blocks 922a, 922b, . . . , 922n). The first part 910 may include fields of an uplink grant such as a DCI format 0_1. The first part 910 may include all of the fields or a subset thereof. The second part 920 may explicitly indicate CSI-IM resources for each UE using the blocks 922. Each block 922 may indicate a CSI-IM resource set. Each victim UE may be configured with an index 924 corresponding to one of the one or more blocks. Each victim UE may generate a CLI report based on the CSI-IM resource set in the block 922 corresponding to the index 924 of the individual victim UE. For example, a victim UE may be configured with the index 924 that points to the block 922a. The block 922a may indicate a CSI-IM resource set which is used by victim UE to measure CLI.

In some implementations, the group common DCI 900 may implicitly indicate the CSI-IM resources. That is, the group common DCI 900 may not include the second part 920. The first part 910 may still include all of the fields of a DCI format 0_1 or a subset thereof for configuring the aggressor UE with a PUSCH transmission. The victim UEs may use preconfigured rules and/or a PUSCH RRC configuration to determine the DMRS location of the PUSCH transmission from the aggressor UE. For example, a victim UE may determine a mapping between DMRS and CSI-IM resources based on RRC configured CSI-IM resources which are dedicated for CLI measurement. The base station may configure the victim UE with CSI-IM resources on different symbols which cover different DMRS locations. If more than one CSI-IM resource is configured on the same symbol, the victim UE may choose a measurement resource based on pre-configured rules. For example, the UE may frequency domain resources corresponding to a previous transmission. As another example, a victim UE may determine a mapping between DMRS and CSI-IM resources based on RRC configured CSI-IM resources and a preconfigured mapping between CSI-IM resource indices and the DMRS time and frequency location.

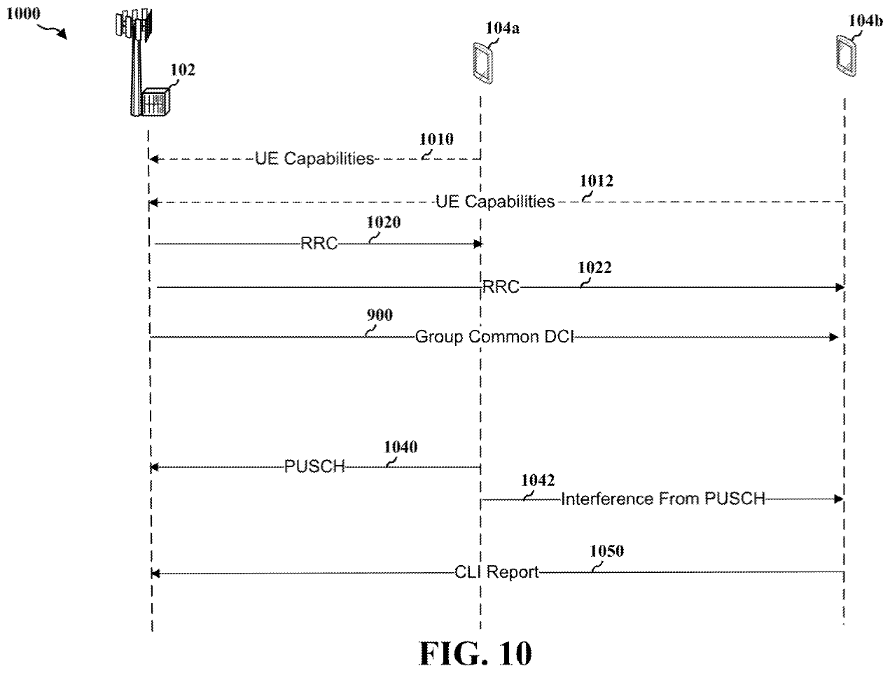

FIG. 10 is a message diagram 1000 illustrating example messages for CLI reporting with dynamic scheduling. A base station 102 may be a serving base station for an aggressor UE 104a and a victim UE 104b. Both the aggressor UE 104a and the victim UE 104b may transmit UE capabilities 1010, 1012 indicating the respective capabilities of the UE 104 with respect to CLI reporting. The base station 102 may configure the aggressor UE 104a via RRC signaling 1020. For example, the RRC signaling 1020 may indicate a PUSCH configuration indicating a DMRS pattern. The base station 102 may configure the victim UE 104b via RRC signaling 1022. For example, the RRC signaling 1022 may indicate one or more CSI-IM resource sets and the index 924. The base station 102 may transmit the group common DCI 900 to both the aggressor UE 104a and the victim UE 104b. The group common DCI 900 may indicate the PUSCH resources to the aggressor UE 104a. The group common DCI 900 may indicate the CSI-IM resources to the victim UE 104b. The aggressor UE 104a may transmit a PUSCH 1040 based on the group common DCI 900. The victim UE 104b may receive the PUSCH 1040 as interference 1042. The victim UE 104b may measure the interference 1042 from the PUSCH 1040 on the CSI-IM resources. The victim UE 104b may generate a CLI report 1050 based on the measurements.

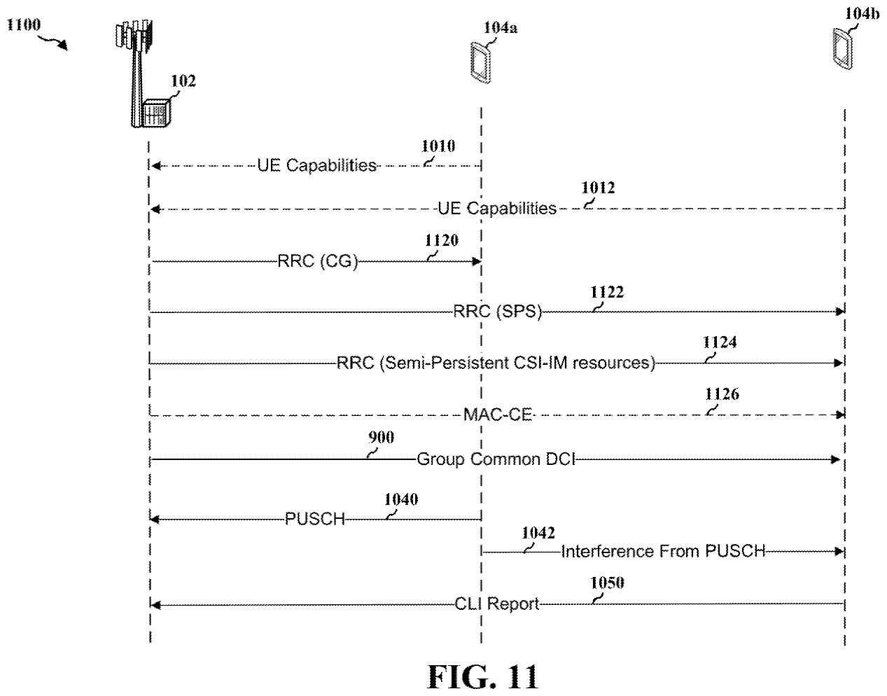

FIG. 11 is a message diagram 1100 illustrating example messages for CLI reporting with semi-persistent scheduling. A base station 102 may be a serving base station for an aggressor UE 104a and a victim UE 104b. Both the aggressor UE 104a and the victim UE 104b may transmit UE capabilities 1010, 1012 indicating the respective capabilities of the UE 104 with respect to CLI reporting.

In an aspect, a group common DCI 900 may be used to activate a configured grant (CG) 1120 in the UL and a semi-persistent scheduling (SPS) 1122 in the DL. Generally, in SPS, PDSCH transmissions are scheduled by an RRC message. The SPS is activated using a DCI. Similarly, for CG, the base station schedules uplink transmissions using an RRC message. There are two types of UL CGs: Type1 provides semi-static scheduling without a DCI trigger and Type2 provides semi-static scheduling with a DCI trigger. To be able to characterize CLI from CG UL transmissions from aggressor UEs to DL transmissions of victim UEs, the base station may pair UL CG from one or more aggressor UEs with SPS scheduling for victims. In an implementation, the base station may group victim and aggressor UEs based on whether the scheduled UL CG and DL SPS are overlapping in the time domain. The base station may send a group common DCI 900 to activate both CG UL (type-2) transmission from one or more aggressor UE and SPS DL scheduling for one or more victim UEs. In another implementation, the base station may configure a victim UE with semi-persistent CSI-IM resources 1124 for measuring CLI from aggressor UEs. The periodicity and offset of the SP CSI-IM resources 1124 may be chosen to match CG UL transmissions from the aggressor UEs. The SP CSI-IM resources 1124 may be activated via a MAC-CE 1126. In some implementations, a group common DCI 900 can trigger the semi-persistent CSI-IM resources 1124 and semi-persistent CLI reporting. The group common DCI 900 may include the second part 920 with multiple blocks 922. Each victim UE may be configured with an index 924 that points to one of the blocks 922. Each block 922 may include a CLI request field that indicates which CSI-IM resource set should be used for CLI measurement.

In an aspect, the victim UE may measure CLI using different quasi-co-location (QCL) spatial relation parameters, which may be referred to as QCL-TypeD. The base station may configure the victim UE with semi-persistent CSI-IM resources for measuring CLI. The base station may define a transmission configuration indicator (TCI) state for CSI-IM indicating a QCL spatial relation parameter. In some implementations, the base station may define a TCI state list for a CSI-IM resource set. Each TCI state in the list may correspond to one CSI-IM resource in the set. The same TCI states may be used in all measurement instances for a semi-persistent CSI-IM resource set. In some implementations, the base stations may define a TCI state list for a CSI-IM resource set. All resources in the set may use one of the TCI states. The victim UE may cycle over the TCI state list in measurement instances. For example, the victim UE may use a first TCI state for a first measurement instance, a second TCI state for a second measurement instance, and so on. Accordingly, the victim UE may provide information about the spatial relation between the victim UE and the aggressor UE. For instance, the base station may select a TCI state for downlink transmissions that experiences the least CLI. In some implementations, the base station may define a sequence of TCI state lists for a CSI-IM resource set. The victim UE may cycle over the sequence of TCI state lists for multiple measurement instances of the semi-persistent CSI-IM resources. The victim UE may use one of the lists of TCI states for each instance of the semi-persistent CSI-IM resources.

In some implementations, the base station may configure the victim UE with semi-persistent CLI reporting based on the semi-persistent CSI-IM resources. The UE may drop a semi-persistent CLI report if the measured CLI is less than a threshold. In some implementations, where the victim UE measures CLI for different QCL spatial relation parameters, the victim UE may average CLI values for the same QCL spatial relation parameter. In each report, the victim UE may report all the pairs (CLI value, QCL-D) or the victim UE may report one pair in each report and cycle over the different pairs across the multiple reports. In some implementations, the victim UE may average CLI values over all QCL spatial relation parameters and report a single CLI value to the base station.

In some implementations, a group common DCI may be used to active a DL SPS. As discussed above, for UL CG type-1, the base station does not send a DCI to activate the UL transmission. The aggressor UE may or may not transmit a PUSCH transmission, for example, based on a transmission buffer of the aggressor UE. The base station may send a group common DCI 900 to activate the SPS scheduling for one or more victim UEs. The base station may configure a victim UE with semi-persistent CSI-IM resources for measuring CSI from the CG UL of the aggressor UE. The periodicity and offset of the semi-persistent CSI-IM resources may be chosen to match UL CG transmissions from one or more aggressor UEs. In some implementations, the base station may filter CLI reports based on whether there was a PUSCH transmission from one of the aggressor UEs on a configured measurement occasion. In some implementations, each victim UE may drop a configured CLI report if the measured CLI value is less than a threshold, which may indicate that the aggressor UE did not transmit the PUSCH transmission using the UL CG. Accordingly, CLI measurements may accurately indicate interference caused by actual PUSCH transmissions.

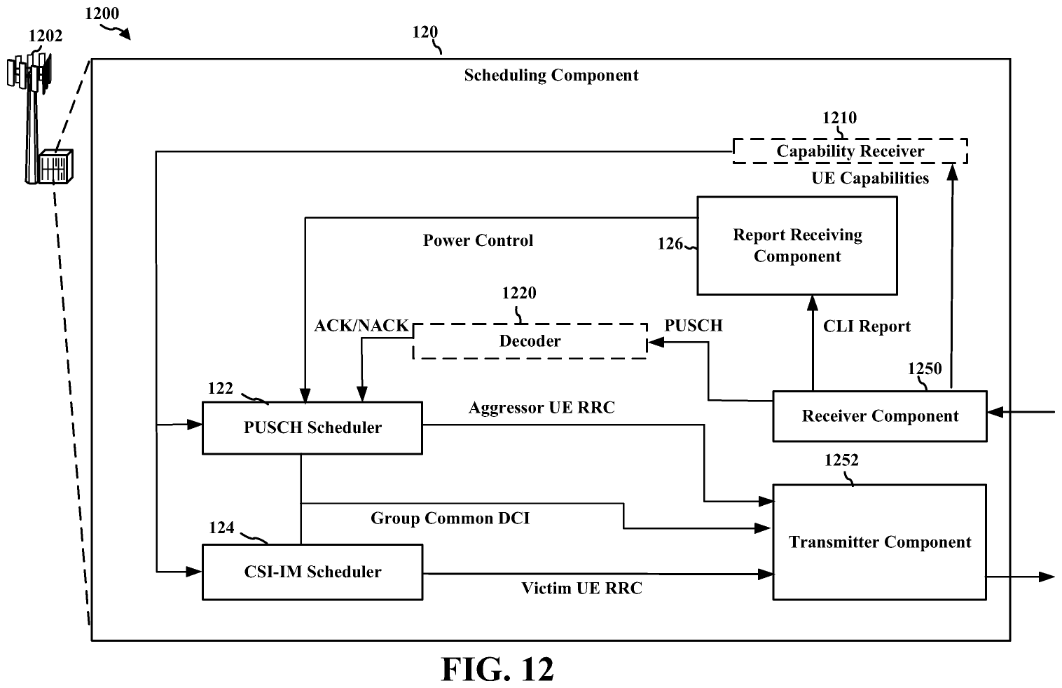

FIG. 12 is a conceptual data flow diagram 1200 illustrating the data flow between different means/components in an example base station 1202, which may be an example of the base station 102 including the scheduling component 120. The scheduling component 120 may include the PUSCH scheduler 122, the CSI-IM scheduler 124, and the report component 126. The scheduling component 120 may include the PUSCH scheduler 122, the CSI-IM scheduler 124, and the report component 126. In some implementations, the scheduling component 120 may optionally include a capability receiver 1210 for receiving an indication of UE capabilities 1010, 1012. In some implementations, the scheduling component 120 may optionally include a decoder for decoding a received PUSCH. The scheduling component 120 also may include a receiver component 1250 and a transmitter component 1252. The receiver component 1250 may include, for example, a RF receiver for receiving the signals described herein. The transmitter component 1252 may include for example, an RF transmitter for transmitting the signals described herein. In some implementations, the receiver component 1250 and the transmitter component 1252 may be co-located in a transceiver.

The receiver component 1250 may receive uplink signals from multiple UEs 104. For example, the receiver component 1250 may receive a PUSCH from the aggressor UE 104a and a CLI report from the victim UE 104b. The receiver component 1250 may receive UE capabilities 1010, 1012 from any UE. The receiver component 1250 may provide the CLI report to the report component 126. The receiver component 1250 may provide the UE capabilities to the capability receiver 1210. The receiver component 1250 may provide the PUSCH to a decoder 1220.

The capability receiver 1210 may receive one or more indications of UE capabilities 1010, 1012. The capability receiver 1210 may determine whether a UE is to be a victim UE or an aggressor UE based on the received capabilities. In some implementations, a UE may be capable of being either a victim UE or an aggressor UE. The role of a particular UE may vary based on scheduling within a particular slot. Additionally, for a full-duplex UE, the UE may be considered both an aggressor UE and victim UE when scheduled to transmit and receive in the same slot. The capability receiver 1210 may provide the capabilities of an aggressor UE to the PUSCH scheduler 122. The capability receiver 1210 may provide the capabilities of a victim UE to the CSI-IM scheduler 124.

The decoder 1220 may receive a PUSCH from an aggressor UE via the receiver component 1250. The decoder 1220 may attempt to decode the received PUSCH based on a PUSCH configuration. The decoder 1220 may determine a decoding status of the PUSCH (either ACK or NACK) based on whether the decoding is successful. The decoder 1220 may provide the decoding status to the PUSCH scheduler 122 to indicate whether the PUSCH should be retransmitted.

The PUSCH scheduler 122 may receive UE capabilities of an aggressor UE from the capability receiver 1210. The PUSCH scheduler 122 may receiver power control information from the report component 126. The PUSCH scheduler 122 may receive an ACK/NACK for a PUSCH from the decoder 1220. The PUSCH scheduler 122 may also receiver other information for scheduling such as channel estimates, a scheduling request, or buffer status report. The PUSCH scheduler 122 may determine a PUSCH configuration for the aggressor UE based on the available information. For example, the PUSCH scheduler 122 may determine a number of resources for transmitting an amount of data given limits imposed by the power control information and channel conditions. The PUSCH scheduler 122 may schedule the aggressor UE to transmit one or more PUSCH transmissions. For example, the PUSCH scheduler 122 may transmit an aggressor UE RRC message via the transmitter component 1252. In some implementations, depending on UE capabilities, the PUSCH scheduler 122 may transmit a group common DCI 900, where the first part 910 may indicate PUSCH parameters.

The CSI-IM scheduler 124 may receive UE capabilities for one or more victim UEs from the capability receiver 1210. The CSI-IM scheduler 124 may receive an indication of the PUSCH scheduling from the PUSCH scheduler 122. The CSI-IM scheduler 124 may configure the one or more victim UEs to measure CLI based on a scheduled PUSCH transmission. In particular, the CSI-IM scheduler 124 may transmit a victim UE RRC configuration that indicates one or more CSI-IM resource sets corresponding to DMRS symbols of the PUSCH transmission. The victim UE RRC configuration may also indicate a CLI reporting configuration. In some implementations, the CSI-IM scheduler 124 may transmit the group common DCI 900, or the second part 920, to indicate a specific CSI-IM resource set to use for a PUSCH transmission.

The report component 126 may receive a CLI report from one or more victim UEs 104. The report component 126 may determine effects of cross-link interference on the victim UEs. In some implementations, the report component 126 may adjust scheduling based on the CLI reports. For example, the report component 126 may provide power control information for PUSCH transmissions that may limit CLI experienced by the victim UEs.

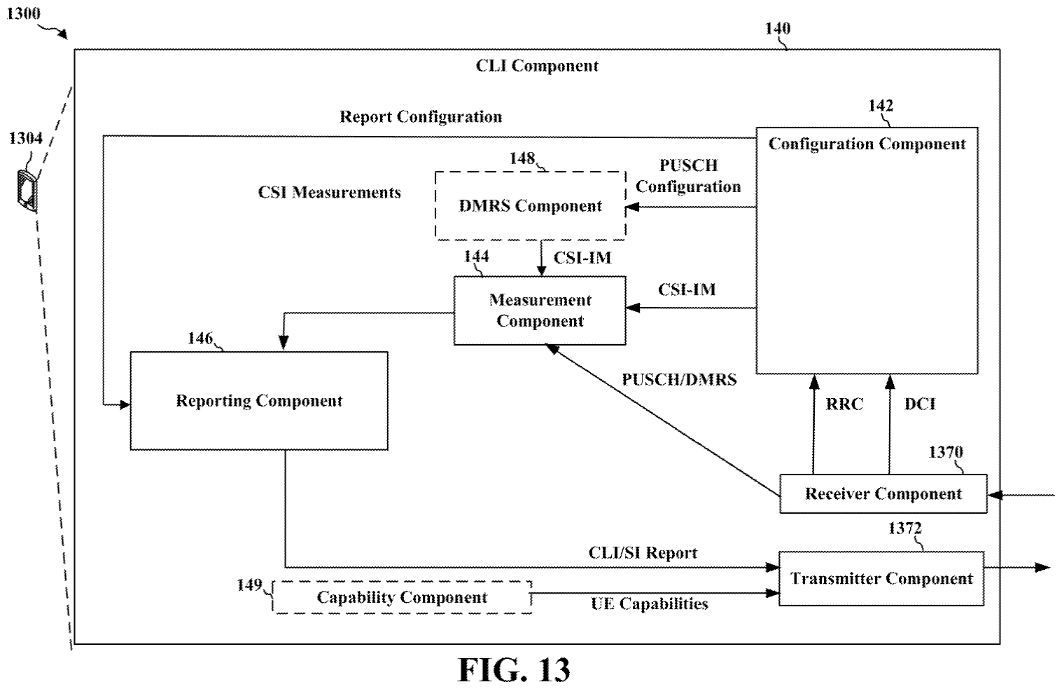

FIG. 13 is a conceptual data flow diagram 1300 illustrating the data flow between different means/components in an example UE 1304, which may be an example of the UE 104 (e.g., victim UE 104b) and include the CLI component 140.

As discussed with respect to FIG. 1, the CLI component 140 may include the configuration component 142, the measurement component 144, and the reporting component 146. In some implementations, the CLI component 140 may include the DMRS component 148. In some implementations, the CLI component 140 may include the capability component 149. The CLI component 140 also may include a receiver component 1370 and a transmitter component 1372. The receiver component 1370 may include, for example, a radio-frequency (RF) receiver for receiving the signals described herein. The transmitter component 1372 may include for example, an RF transmitter for transmitting the signals described herein. In some implementations, the receiver component 1370 and the transmitter component 1372 may be co-located in a transceiver.

The receiver component 1370 may receive downlink signals such as the RRC signaling 1022 or the group common DCI 900. The receiver component 1370 may receive cross-link interference such as interference 1042 from the PUSCH 1040. The receiver component 1370 may provide the RRC signaling 1022 and the group common DCI 900 to the configuration component 142. The receiver component 1370 may provide the cross link interference to the measurement component 144.

The configuration component 142 may receive the RRC signaling 1020 from the receiver component 1370. The configuration component 142 may extract RRC configured parameters from the RRC signaling 1020, for example, by decoding the RRC signaling. For example, the configuration component 142 may extract a slot format, one or more CSI-IM configurations such as a sequence of FD allocations or finite state machine parameters, a group common DCI index 924, and/or one or more SPS configurations. The configuration component 142 may receive the group common DCI 900 from the receiver component 1370. For dynamic scheduling, the configuration component 142 may determine a CSI-IM resource set based on the block 922 corresponding to the index 924 or implicitly based on the first part 910. For SPS scheduling, the configuration component 142 may determine to activate an SPS configuration and/or semi-persistent CSI-IM resources based on the group common DCI 900. In either case, the configuration component 142 may determine the CSI-IM resources to measure. The configuration component 142 may provide the CSI-IM resources to the measurement component 144. In some implementations, the RRC configuration and/or the group common DCI 900 may not explicitly indicate the CSI-IM resources. Instead, the RRC configuration and/or the group common DCI 900 may indicate the PUSCH configuration (e.g., the first part 910) of one or more aggressor UEs 104a. In these implementations, the configuration component 142 may provide the PUSCH configuration to the DMRS component 148. The configuration component 142 may also determine a CLI report configuration. The CLI report configuration may include a number and type of CLI value and uplink resources for transmitting the CLI report. The configuration component 142 may provide the CLI report configuration to the reporting component 146.

The DMRS component 148 may receive the PUSCH configuration from the configuration component 142. The DMRS component 148 may determine CSI-IM resources based on the PUSCH configuration. For example, the DMRS component 148 may determine DMRS locations indicated in the PUSCH configuration or determine the DMRS locations based on preconfigured rules (e.g., according to the slot format). The DMRS component 148 may be configured with a set of CSI-IM resources on different symbols that cover different DMRS locations. The DMRS component 148 may select configured CSI-IM resources that cover the DMRS locations for the PUSCH 1040. If more than one CSI-IM resource is configured on the same symbol, the DMRS component 148 may choose a CSI-IM resource based on preconfigured rules. Alternatively, the DMRS component 148 may be configured with a mapping between CSI-IM resource indices and the time and frequency location of a DMRS. The DMRS component 148 may provide the selected CSI-IM resources to the measurement component 144.

The measurement component 144 may receive the CSI-IM resources from the configuration component 142 and/or the DMRS component 148. The measurement component 144 may perform measurements on the CSI-IM resources. The base station 102 may refrain from transmitting on the CSI-IM resources, so any signal received on the CSI-IM resources may be considered cross-link interference. In an aspect, the measurement component 144 may measure a received signal strength indicator (RSSI) to capture the amount of cross-link interference. In some implementations, the measurement component 144 may measure a reference signal received power (RSRP). In some implementations, the measurement component 144 may adjust a measured CLI value based on a ratio of PUSCH EPRE to DMRS EPRE.

The reporting component 146 may transmit a CLI report based on the report configuration and the measurements. For example, the reporting component 146 may determine a number of CLI values to report. The reporting component 146 may average the measurement values if indicated by the report configuration. The reporting component 146 may determine uplink resources for the CLI report based on the report configuration. The reporting component 146 may transmit the CLI report via the transmitter component 1372.

The capability component 149 may transmit an indication of one or more capabilities of the UE 1304 related to CLI reporting as described herein. For example, the capability component 149 may transmit an RRC message indicating whether the UE 1304 is capable of performing any of the actions described herein. Example capabilities that may be reported include: CLI or SI measurement in CSI-IM resources; a common DCI for PUSCH configuration; a common DCI for triggering CLI measurement and reporting; explicit or implicit indication of CSI-IM resources in common DCI; a common DCI for triggering configured grants in uplink; a common DCI for triggering SPS for downlink; a common DCI for triggering semi-persistent CSI-IM resources; a common DCI for triggering semi-persistent CLI reporting; QCL for CLI measurement; or different QCL for semi-persistent CSI-IM measurement occasions.

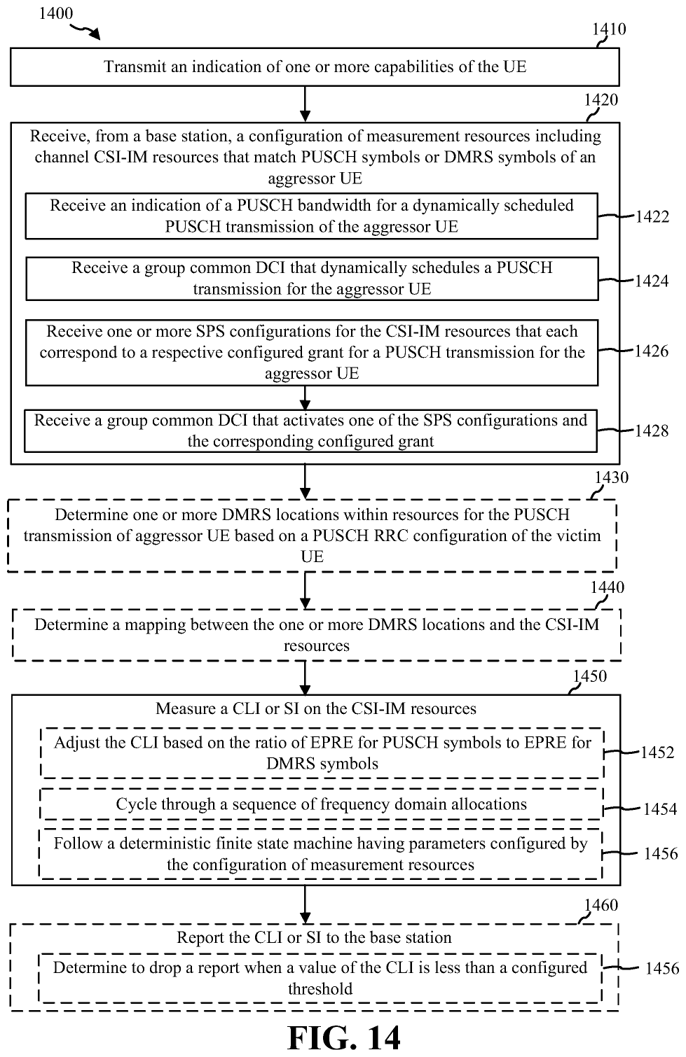

FIG. 14 is a flowchart of an example method 1400 for a victim UE to report CLI. The method 1400 may be performed by a UE (such as the UE 104, which may include the memory 360 and which may be the entire UE 104 or a component of the UE 104 such as the CLI component 140, TX processor 368, the RX processor 356, or the controller/processor 359). The method 1400 may be performed by the CLI component 140 in communication with the scheduling component 120 of the base station 102. Optional blocks are shown with dashed lines.

At block 1410, the method 1400 may optionally include transmitting an indication of one or more capabilities of the UE. In some implementations, for example, the UE 104, the TX processor 368, or the controller/processor 359 may execute the CLI component 140 or the capability component 149 to transmit the indication of one or more capabilities of the UE. Example capabilities may include whether the victim UE supports one or more of: CLI or SI measurement in CSI-IM resources; a common DCI for PUSCH configuration; a common DCI for triggering CLI measurement and reporting; explicit or implicit indication of CSI-IM resources in common DCI; a common DCI for triggering configured grants in uplink; a common DCI for triggering SPS for downlink; a common DCI for triggering semi-persistent CSI-IM resources; a common DCI for triggering semi-persistent CLI reporting; QCL for CLI measurement; or different QCL for semi-persistent CSI-IM measurement occasions. Accordingly, the UE 104, the TX processor 368, or the controller/processor 359 executing the CLI component 140 or the capability component 149 may provide means for transmitting an indication of one or more capabilities of the UE.

At block 1420, the method 1400 may include receiving, from a base station, a configuration of measurement resources including channel CSI-IM resources that match PUSCH symbols or DMRS symbols of an aggressor UE. In some implementations, for example, the UE 104, the RX processor 356, or the controller/processor 359 may execute the CLI component 140 or the configuration component 142 to receive, from the base station 102, a configuration of measurement resources including channel CSI-IM resources that match PUSCH symbols or DMRS symbols of an aggressor UE.

In some implementations, in sub-block 1422, the block 1420 may optionally include receiving an indication of a PUSCH bandwidth for a dynamically scheduled PUSCH transmission of the aggressor UE. The configuration of measurement resources may include aperiodic CSI-IM resources that match the PUSCH bandwidth. The configuration of the CLI report may indicate aperiodic CLI reporting for a sub-band CLI that corresponds to a frequency domain allocation of the PUSCH transmission.

In some implementations, in sub-block 1424, the block 1420 may optionally include receiving a group common DCI 900 that dynamically schedules a PUSCH transmission for the aggressor UE. The group common DCI 900 may include a first part 910 that schedules the PUSCH transmission and a second part 920 including one or more blocks 922, each block indicating a CSI-IM resource set. The victim UE may be configured with an index corresponding to one of the one or more blocks. Accordingly, the second part 920 of the group common DCI 900 may explicitly indicate the CSI-IM resource set. In some implementations, the group common DCI 900 may not include the second part 920 and the method 1400 may include the optional blocks 1430 and 1440 to determine the CSI-IM resources.

In some implementations, in sub-block 1426, the block 1420 may optionally include receiving one or more SPS configurations for the CSI-IM resources that each correspond to a respective configured grant for a PUSCH transmission for the aggressor UE. For example, the one or more SPS configurations may be received as a RRC message indicating SPS scheduling of a PDSCH for the victim UE. In sub-block 1428, the block 1420 may optionally include receiving a group common DCI that activates one of the SPS configurations and the corresponding configured grant.

In some implementations, receiving the configuration of measurement resources in block 1420 may include receiving a configuration of semi-persistent CSI-IM resources. A periodicity and an offset of the semi-persistent CSI-IM resources may match a configured grant of the aggressor UE. The semi-persistent CSI-IM resources may be activated by a MAC-CE. Alternatively, the semi-persistent CSI-IM resources may be activated by a common DCI 900 that includes one or more blocks 922. In this case, each block 922 may indicate a CSI-IM resource set to activate. The victim UE may configured with an index corresponding to one of the one or more blocks. The block may include a CLI request field that indicates which CSI-IM resource set to activate. Accordingly, the victim UE may determine a CSI-IM resource set to activate based on the group common DCI 900. The CLI report configuration may correspond to the activated CSI-IM resource set. In some implementations, the common DCI may also activate an SPS configuration for SPS scheduling of a PDSCH.

In view of the foregoing, the UE 104, the RX processor 356, or the controller/processor 359 executing the CLI component 140 or the configuration component 142 may provide means for receiving, from a base station, a configuration of measurement resources including channel CSI-IM resources that match PUSCH symbols or DMRS symbols of an aggressor UE.

At block 1430, the method 1400 may optionally include determining one or more DMRS locations within resources for the PUSCH transmission of aggressor UE based on a PUSCH RRC configuration of the victim UE. The block 1430 may be in response to receiving a group common DCI 900 including the first part 910. In some implementations, for example, the UE 104, the TX processor 368, or the controller/processor 359 may execute the CLI component 140 or the DMRS component 148 to determine one or more DMRS locations within resources for the PUSCH transmission of aggressor UE based on a PUSCH RRC configuration of the victim UE. For example, the victim UE and the aggressor UE may share a PUSCH RRC configuration. Accordingly, the victim UE may determine the time domain locations of the DMRS symbols within a PUSCH transmission. Accordingly, the UE 104, the TX processor 368, or the controller/processor 359 executing the CLI component 140 or the DMRS component 148 may provide means for determining one or more DMRS locations within resources for the PUSCH transmission of aggressor UE based on a PUSCH RRC configuration of the victim UE.

At block 1440, the method 1400 may optionally include determining a mapping between the one or more DMRS locations and the CSI-IM resources. In some implementations, for example, the UE 104, the TX processor 368, or the controller/processor 359 may execute the CLI component 140 or the DMRS component 148 to determine the mapping between the one or more DMRS locations and the CSI-IM resources. For example, the victim UE may be configured with CSI-IM resource sets on different symbols that cover different DMRS locations. Determining the mapping may include selecting a CSI-IM resource set that covers the one or more DMRS locations. As another example, the victim UE may be configured with a mapping between CSI-IM resource sets and DMRS locations. Accordingly, the UE 104, the TX processor 368, or the controller/processor 359 executing the CLI component 140 or the DMRS component 148 may provide means for determining a mapping between the one or more DMRS locations and the CSI-IM resources.

At block 1450, the method 1400 may include measuring a CLI or SI on the CSI-IM resources. In some implementations, for example, the UE 104, the RX processor 356, or the controller/processor 359 may execute the CLI component 140 or the measurement component 144 to measure a CLI or SI on the CSI-IM resources. In some implementations, the configuration of measurement resources includes a ratio of an EPRE for the PUSCH symbols to EPRE for the DMRS symbols. In sub-block 1452, the block 1450 may optionally include adjusting the CLI based on the ratio. For instance, the configuration of measurement resources may include a plurality of CSI-IM resources and a list of scaling values, each scaling value may correspond to one CSI-IM resource having an associated ratio for an aggressor UE. The victim UE may adjust the measurement of each CSI-IM resource based on the corresponding scaling factor.

In some implementations, where the configuration of measurement resources includes a periodic or semi-persistent CSI-IM, a frequency domain allocation of the CSI-IM may change from slot to slot. In sub-block 1454, the block 1450 may include cycling through a sequence of frequency domain allocations. Alternatively, in sub-block 1456, the block 1450 may include following a deterministic finite state machine having parameters configured by the configuration of measurement resources. As yet another example, the CSI-IM resource frequency domain allocation may predefined rules based on a slot format and the victim UE may measure the CLI or CSI based on the CSI-IM resource frequency domain allocation for a slot.

In some implementations, the configuration of measurement resources may include a configuration of semi-persistent CSI-IM resources and a TCI state for CSI-IM indicating a QCL spatial receive parameter. The TCI state may be associated with each semi-persistent CSI-IM resource. Measuring the CLI may include using the TCI state associated with each semi-persistent CSI-IM resource for each instance of the semi-persistent CSI-IM resource. In some implementations, the configuration of measurement resources may indicate a list of TCI states associated with the semi-persistent CSI-IM resources. Measuring the CLI may include cycling over the list of TCI states for multiple instances of the semi-persistent CSI-IM resources. In some implementations, the configuration of measurement resources may indicate a sequence of lists of TCI states associated with the semi-persistent CSI-IM resources. Measuring the CLI may include cycling over the lists of TCI states for multiple instances of the semi-persistent CSI-IM resources. The victim UE may use one of the lists of TCI states for each instance of the semi-persistent CSI-IM resources. In view of the foregoing, the UE 104, the RX processor 356, or the controller/processor 359 executing the CLI component 140 or the measurement component 144 may provide means for measuring a CLI or SI on the CSI-IM resources.

At block 1460, the method 1400 may include reporting the CLI or SI to the base station according to the configuration of the CLI report. In some implementations, for example, the UE 104, the TX processor 368, or the controller/processor 359 may execute the CLI component 140 or the reporting component 146 to report the CLI or SI to the base station according to the configuration of the CLI report. For instance, the CLI or SI may include a value for each DMRS symbol or an average value over DMRS symbols depending on the configuration of the CLI report. In some implementations, at sub-block 1456, the block 1450 may include determining to drop a report when a value of the CLI is less than a configured threshold. For example, the value of the CLI may be an average of CLI values for the same QCL spatial receive parameter and the report may include pairs of a CLI value and a QCL spatial receive parameter. In some implementations, only pairs where the CLI value satisfies the configured threshold may be included. In other implementations, the CLI value may be an average of CLI values over all QCL spatial receive parameters. Accordingly, the UE 104, the TX processor 368, or the controller/processor 359 executing the CLI component 140 or the capability component 149 may provide means for reporting the CLI or SI to the base station according to the configuration of the CLI report.

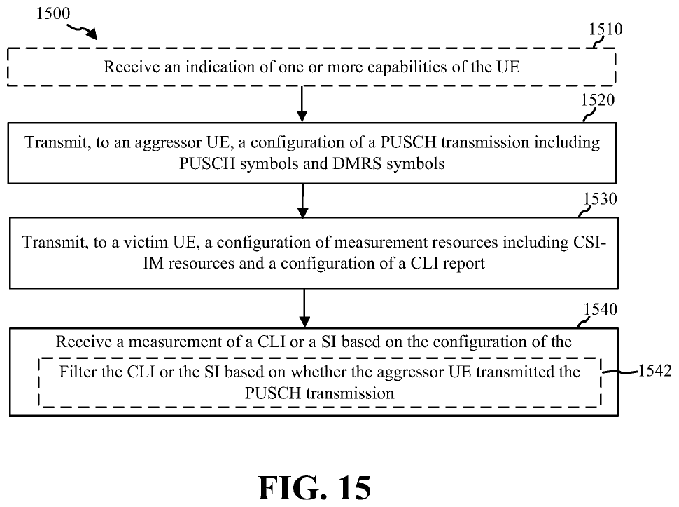

FIG. 15 a flowchart of an example method 1500 for a base station to schedule a PUSCH for an aggressor UE and a corresponding CSI-IM for a victim UE for CLI reporting. The method 1500 may be performed by a base station (such as the base station 102, which may include the memory 376 and which may be the entire base station 102 or a component of the base station 102 such as the scheduling component 120, TX processor 316, the RX processor 370, or the controller/processor 375). The method 1500 may be performed by the scheduling component 120 in communication with the CLI component 140 of the victim UE 104b and the PUSCH component of the aggressor UE 104a.

At block 1510, the method 1500 may optionally include receiving an indication of one or more capabilities of a UE. In some implementations, for example, the base station 102, RX processor 370, or the controller/processor 375 may execute the scheduling component 120 or the capability receiver 1210 to receive an indication of one or more capabilities of the UE. The UE may be the aggressor UE 104a, the victim UE 104b, or both. Accordingly, the base station 102, RX processor 370, or the controller/processor 375 executing the scheduling component 120 or the capability receiver 1210 may provide means for receiving an indication of one or more capabilities of the UE.

At block 1520, the method 1500 may include transmitting, to an aggressor UE, a configuration of a PUSCH transmission including PUSCH symbols and DMRS symbols. In some implementations, for example, the base station 102, TX processor 316, or the controller/processor 375 may execute the scheduling component 120 or the PUSCH scheduler 122 to transmit, to an aggressor UE, a configuration of a PUSCH transmission including PUSCH symbols and DMRS symbols. Accordingly, the base station 102, TX processor 316, or the controller/processor 375 executing the scheduling component 120 or the PUSCH scheduler 122 may provide means for transmitting, to an aggressor UE, a configuration of a PUSCH transmission including PUSCH symbols and DMRS symbols.

At block 1530, the method 1500 may include transmitting, to a victim UE, a configuration of measurement resources including CSI-IM resources and a configuration of a CLI report. In some implementations, for example, the base station 102, TX processor 316, or the controller/processor 375 may execute the scheduling component 120 or the CSI-IM scheduler 124 to transmit, to a victim UE, a configuration of measurement resources including CSI-IM resources and a configuration of a CLI report. Accordingly, the base station 102, TX processor 316, or the controller/processor 375 executing the scheduling component 120 or the CSI-IM scheduler 124 may provide means for transmitting, to a victim UE, a configuration of measurement resources including CSI-IM resources and a configuration of a CLI report.

At block 1540, the method 1500 may include receiving a measurement of a CLI or a SI based on the configuration of the measurement resources. In some implementations, for example, the base station 102, RX processor 370, or the controller/processor 375 may execute the scheduling component 120 or the report component 126 to receive a measurement of a CLI or a SI based on the configuration of the measurement resources. In some implementations, at sub-block 1542, the block 1540 may include filtering the CLI or the SI based on whether the aggressor UE transmitted the PUSCH transmission. For example, the report component 126 may determine whether the decoder 1220 received the PUSCH transmission corresponding to the CLI or the SI, and ignore reported CLI or SI values that do not correspond to a received PUSCH transmission. Accordingly, the base station 102, RX processor 370, or the controller/processor 375 executing the scheduling component 120 or the report component 126 may provide means for receiving a measurement of a CLI or a SI based on the configuration of the measurement resources.

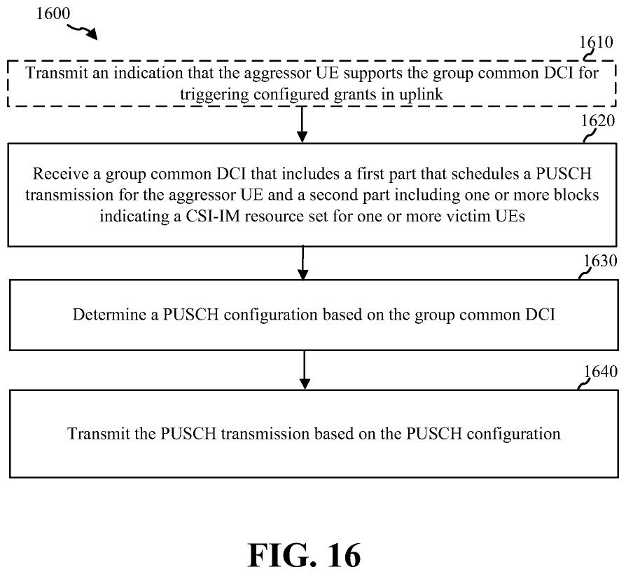

FIG. 16 is a flowchart of an example method 1600 for an aggressor UE to transmit a PUSCH transmission based on a group common DCI. The method 1600 may be performed by a UE (such as the UE 104, which may include the memory 360 and which may be the entire UE 104 or a component of the UE 104 such as the PUSCH component 198, TX processor 368, the RX processor 356, or the controller/processor 359). The method 1600 may be performed by the PUSCH component 198 in communication with the scheduling component 120 of the base station 102. Optional blocks are shown with dashed lines.

At block 1610, the method 1600 may optionally include transmitting an indication that the aggressor UE supports the group common DCI for triggering configured grants in uplink. In some implementations, for example, the UE 104, the TX processor 368, or the controller/processor 359 may execute the PUSCH component 198 or the capability component 149 to transmit the indication that the aggressor UE supports the group common DCI for triggering configured grants in uplink. Accordingly, the UE 104, the TX processor 368, or the controller/processor 359 executing the PUSCH component 198 or the capability component 149 may provide means for transmitting an indication that the aggressor UE supports the group common DCI for triggering configured grants in uplink.

At block 1620, the method 1600 may include receiving a group common DCI that includes a first part that schedules a PUSCH transmission for the aggressor UE and a second part including one or more blocks indicating a CSI-IM resource set for one or more victim UEs. In some implementations, for example, the UE 104, the RX processor 356, or the controller/processor 359 may execute the PUSCH component 198 to receive the group common DCI 900 that includes the first part 910 that schedules a PUSCH transmission for the aggressor UE and a second part 920 including one or more blocks 922 indicating a CSI-IM resource set for one or more victim UEs. Accordingly, the UE 104, the RX processor 356, or the controller/processor 359 executing the PUSCH component 198 may provide means for receiving, from a base station, a configuration of measurement resources including channel CSI-IM resources that match PUSCH symbols or DMRS symbols of an aggressor UE.

At block 1630, the method 1600 may include determining a PUSCH configuration based on the group common DCI. In some implementations, for example, the UE 104, the RX processor 356, or the controller/processor 359 may execute the PUSCH component 198 to determine the PUSCH configuration based on the group common DCI 900. Accordingly, the UE 104, the RX processor 356, or the controller/processor 359 executing the PUSCH component 198 may provide means for determining the PUSCH configuration based on the group common DCI.

At block 1640, the method 1600 may include transmitting the PUSCH transmission based on the PUSCH configuration. In some implementations, for example, the UE 104, the TX processor 368, or the controller/processor 359 may execute the PUSCH component 198 to transmit the PUSCH transmission based on the PUSCH configuration. Accordingly, the UE 104, the TX processor 368, or the controller/processor 359 executing the PUSCH component 198 may provide means for transmitting the PUSCH transmission based on the PUSCH configuration.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication for a victim user equipment (UE), comprising:
receiving, from a base station, a configuration of measurement resources including channel state information interference measurement (CSI-IM) resources and a configuration of a cross-link interference (CLI) report, wherein the CSI-IM resources match physical uplink shared channel (PUSCH) symbols or demodulation reference signal (DMRS) symbols of an aggressor UE;
measuring a CLI or a self-interference (SI) on the CSI-IM resources; and
reporting the CLI or the SI to the base station according to the configuration of the CLI report.

2. The method of claim 1, wherein the CLI or the SI includes a value for each DMRS symbol.

3. The method of claim 1, wherein the CLI or the SI includes an average value over DMRS symbols.

4. The method of claim 1, wherein the configuration of the measurement resources includes a ratio of an energy per resource element (EPRE) for the PUSCH symbols to EPRE for the DMRS symbols, and wherein measuring the CLI or the SI comprises adjusting the CLI based on the ratio.

5. The method of claim 4, wherein the configuration of the measurement resources includes a plurality of CSI-IM resources and a list of scaling values, each scaling value corresponding to one CSI-IM resource.

6. The method of claim 1, wherein receiving the configuration of the measurement resources and CLI reporting comprises receiving an indication of a PUSCH bandwidth for a dynamically scheduled PUSCH transmission of the aggressor UE.

7. The method of claim 6, wherein the configuration of the measurement resources includes aperiodic CSI-IM resources that match the PUSCH bandwidth.

8. The method of claim 6, wherein the configuration of the CLI report indicates aperiodic CLI reporting for a sub-band CLI that corresponds to a frequency domain allocation of the PUSCH transmission.

9. The method of claim 6, wherein the configuration of the measurement resources includes a periodic or semi-persistent CSI-IM where a frequency domain allocation of the CSI-IM changes from slot to slot.

10. The method of claim 9, wherein measuring the CLI or the SI on the CSI-IM resources comprises cycling through a sequence of frequency domain allocations.

11. The method of claim 9, wherein measuring the CLI or the SI on the CSI-IM resources comprises following a deterministic finite state machine having parameters configured by the configuration of the measurement resources.

12. The method of claim 9, wherein the CSI-IM resource frequency domain allocation follows predefined rules based on a slot format.

13. The method of claim 1, wherein receiving the configuration of the measurement resources comprises receiving a group common downlink control information (DCI) that dynamically schedules a PUSCH transmission for the aggressor UE.

14. The method of claim 13, wherein the group common DCI includes a first part that schedules the PUSCH transmission and a second part including one or more blocks, each block indicating a CSI-IM resource set, wherein the victim UE is configured with an index corresponding to one of the one or more blocks.

15. The method of claim 13, further comprising:
determining one or more DMRS locations within resources for the PUSCH transmission of aggressor UE based on a PUSCH radio resource control (RRC) configuration of the victim UE using preconfigured rules; and
determining a mapping between the one or more DMRS locations and the CSI-IM resources.

16. The method of claim 15, wherein the victim UE is configured with CSI-IM resource sets on different symbols that cover different DMRS locations, wherein determining the mapping comprises selecting a CSI-IM resource set that covers the one or more DMRS locations.

17. The method of claim 15, wherein the victim UE is configured with a mapping between CSI-IM resource sets and DMRS locations.

18. The method of claim 1, wherein receiving the configuration of the measurement resources comprises:
receiving one or more semi-persistent scheduling (SPS) configurations for the CSI-IM resources that each correspond to a respective configured grant for a PUSCH transmission for the aggressor UE; and
receiving a group common DCI that activates one of the SPS DL configurations and the corresponding UL configured grant.

19. The method of claim 1, wherein receiving the configuration of the measurement resources comprises receiving a configuration of semi-persistent CSI-IM resources, wherein a periodicity and an offset of the semi-persistent CSI-IM resources match a configured grant of the aggressor UE.

20. The method of claim 19, wherein the semi-persistent CSI-IM resources are activated by a media access control (MAC) control element (CE).

21. The method of claim 19, wherein the semi-persistent CSI-IM resources are activated by a common DCI that includes one or more blocks, each block indicating a CSI-IM resource set to activate, wherein the victim UE is configured with an index corresponding to one of the one or more blocks.

22. The method of claim 19, wherein reporting the CLI to the base station comprises determining to drop a report when a value of the CLI is less than a configured threshold.

23. The method of claim 19, wherein reporting the CLI to the base station comprises reporting the CLI regardless of whether a PUSCH transmission occurs on the CSI-IM resource.

24. The method of claim 1, wherein receiving the configuration of the measurement resources comprises:
receiving one or more semi-persistent scheduling (SPS) configurations for the CSI-IM resources that each correspond to a respective configured grant for a PUSCH transmission for the aggressor UE;
receiving a configuration of semi-persistent CSI-IM resources, wherein a periodicity and an offset of the semi-persistent CSI-IM resources match a configured grant of the aggressor UE; and
receiving a group common DCI that activates one of the SPS DL configurations and the CLI reporting based on the configuration of semi-persistent CSI-IM resources.

25. The method of claim 1, wherein receiving the configuration of the measurement resources comprises receiving a configuration of semi-persistent CSI-IM resources and a transmission configuration indicator (TCI) state for CSI-IM indicating a quasi-co-location (QCL) spatial receive parameter.

26. The method of claim 25, wherein the configuration of the measurement resources indicates a TCI state associated with each semi-persistent CSI-IM resource, wherein measuring the CLI comprises using the TCI state associated with each semi-persistent CSI-IM resource for each instance of the semi-persistent CSI-IM resource.

27. The method of claim 25, wherein the configuration of the measurement resources indicates a list of TCI states associated with the semi-persistent CSI-IM resources, wherein measuring the CLI comprises cycling over the list of TCI states for multiple instances of the semi-persistent CSI-IM resources.

28. The method of claim 25, wherein the configuration of the measurement resources indicates a sequence of lists of TCI states associated with the semi-persistent CSI-IM resources, wherein measuring the CLI comprises cycling over the lists of TCI states for multiple instances of the semi-persistent CSI-IM resources, wherein the victim UE uses one of the lists of TCI states for each instance of the semi-persistent CSI-IM resources.

29. The method of claim 25, wherein reporting the CLI to the base station comprises determining to drop a report when a value of the CLI is less than a configured threshold.

30. The method of claim 29, wherein the value of the CLI is an average of CLI values for the same QCL spatial receive parameter and a report includes pairs of a CLI value and a QCL spatial receive parameter.

31. The method of claim 29, wherein the value of the CLI is an average of CLI values over all QCL spatial receive parameters.

32. The method of claim 1, further comprising transmitting an indication of whether the victim UE supports one or more of: CLI or SI measurement in CSI-IM resources; a common DCI for PUSCH configuration; a common DCI for triggering CLI measurement and reporting; explicit or implicit indication of CSI-IM resources in common DCI; a common DCI for triggering configured grants in uplink; a common DCI for triggering SPS for downlink; a common DCI for triggering semi-persistent CSI-IM resources; a common DCI for triggering semi-persistent CLI reporting; QCL for CLI measurement; or different QCL for semi-persistent CSI-IM measurement occasions.

33. A method of wireless communication for a base station, comprising:
transmitting, to an aggressor user equipment (UE), a configuration of a physical uplink shared channel (PUSCH) transmission including PUSCH symbols and demodulation reference signal (DMRS) symbols;
transmitting, to a victim UE, a configuration of measurement resources including channel state information interference measurement (CSI-IM) resources and a configuration of a cross-link interference (CLI) report, wherein the CSI-IM resources match the PUSCH symbols or the DMRS symbols of the aggressor UE; and
receiving a measurement of a cross-link interference (CLI) or a self-interference (SI) based on the configuration of the measurement resources.

34. The method of claim 33, wherein the measurement of the CLI or the SI includes a value for each DMRS symbol.

35. The method of claim 33, wherein the measurement of the CLI or the SI includes an average value over DMRS symbols.

36. The method of claim 33, wherein the configuration of the measurement resources includes a ratio of an energy per resource element (EPRE) for the PUSCH symbols to EPRE for the DMRS symbols.

37. The method of claim 36, wherein the configuration of the measurement resources includes a plurality of CSI-IM resources and a list of scaling values, each scaling value corresponding to one CSI-IM resource.

38. The method of claim 33, wherein the configuration of the measurement resources includes an indication of a PUSCH bandwidth for a dynamically scheduled PUSCH transmission of the aggressor UE.

39. The method of claim 38, wherein the configuration of the measurement resources includes aperiodic CSI-IM resources that match the PUSCH bandwidth.

40. The method of claim 38, wherein the configuration of the CLI report indicates aperiodic CLI reporting for a sub-band CLI that corresponds to a frequency domain allocation of the PUSCH transmission.

41. The method of claim 38, wherein the configuration of the measurement resources includes a periodic or a semi-persistent CSI-IM where a frequency domain allocation of the CSI-IM resources changes from slot to slot.

42. The method of claim 41, wherein the measurement of the CLI or the SI cycles through a sequence of frequency domain allocations.

43. The method of claim 41, wherein the measurement of the CLI or the SI follows a deterministic finite state machine having parameters configured by the configuration of the measurement resources.

44. The method of claim 41, wherein the CSI-IM resource frequency domain allocation follows predefined rules based on a slot format.

45. The method of claim 33, wherein the configuration of the measurement resources includes a group common downlink control information (DCI) that dynamically schedules a PUSCH transmission for the aggressor UE.

46. The method of claim 45, wherein the group common DCI includes a first part that schedules the PUSCH transmission and a second part including one or more blocks, each block indicating a CSI-IM resource set, wherein the victim UE is configured with an index corresponding to one of the one or more blocks.

47. The method of claim 33, wherein the configuration of the measurement resources includes:
one or more semi-persistent scheduling (SPS) downlink (DL) configurations for the CSI-IM resources that each correspond to a respective configured grant for a PUSCH transmission for the aggressor UE; and
a group common DCI that activates one of the SPS DL configurations and the corresponding UL configured grant.

48. The method of claim 33, wherein the configuration of the measurement resources includes a configuration of semi-persistent CSI-IM resources, wherein a periodicity and an offset of the semi-persistent CSI-IM resources match a configured grant of the aggressor UE.

49. The method of claim 48, wherein the semi-persistent CSI-IM resources are activated by a media access control (MAC) control element (CE).

50. The method of claim 48, wherein the semi-persistent CSI-IM resources are activated by a group common DCI that includes one or more blocks, each block indicating a CSI-IM resource set to activate, wherein the victim UE is configured with an index corresponding to one of the one or more blocks.

51. The method of claim 48, wherein receiving the measurement of the CLI or the SI based on the configuration of the measurement resources comprises filtering the CLI or the SI based on whether the aggressor UE transmitted the PUSCH transmission.

52. The method of claim 33, wherein the configuration of the measurement resources comprises:
one or more semi-persistent scheduling (SPS) downlink (DL)configurations for the CSI-IM resources that each correspond to a respective configured grant for a PUSCH transmission for the aggressor UE;
a configuration of semi-persistent CSI-IM resources, wherein a periodicity and an offset of the semi-persistent CSI-IM resources match a configured grant of the aggressor UE; and
a group common DCI that activates one of the SPS DL configurations and the CLI reporting based on the configuration of semi-persistent CSI-IM resources.

53. The method of claim 33, wherein the configuration of the measurement resources includes a configuration of semi-persistent CSI-IM resources and a transmission configuration indicator (TCI) state for CSI-IM indicating a quasi-co-location (QCL) spatial receive parameter.

54. The method of claim 53, wherein the configuration of the measurement resources indicates a TCI state associated with each semi-persistent CSI-IM resource.

55. The method of claim 53, wherein the configuration of the measurement resources indicates a list of TCI states associated with the semi-persistent CSI-IM resources.

56. The method of claim 53, wherein the configuration of the measurement resources indicates a sequence of lists of TCI states associated with the semi-persistent CSI-IM resources.

57. The method of claim 53, wherein the measurement of the CLI is an average of CLI values for the same QCL spatial receive parameter and a report includes pairs of a CLI value and a QCL spatial receive parameter.

58. The method of claim 53, wherein the measurement of the CLI is an average of CLI values over all QCL spatial receive parameters.

59. The method of claim 33, further comprising receiving an indication of whether the victim UE supports one or more of: CLI or SI measurement in CSI-IM resources; a common DCI for PUSCH configuration; a common DCI for triggering CLI measurement and reporting; explicit or implicit indication of CSI-IM resources in common DCI; a common DCI for triggering configured grants in uplink; a common DCI for triggering SPS for downlink; a common DCI for triggering semi-persistent CSI-IM resources; a common DCI for triggering semi-persistent CLI reporting; QCL for CLI measurement;
or different QCL for semi-persistent CSI-IM measurement occasions.

60. A method of wireless communication for an aggressor user equipment (UE), comprising:
receiving a group common downlink control information (DCI), wherein the group common DCI includes a first part that schedules a physical uplink shared channel (PUSCH) transmission for the aggressor UE and a second part including one or more blocks, each block indicating a channel state information interference measurement (CSI-IM) resource set for one or more victim UEs;
determining a PUSCH configuration based on the group common DCI; and
transmitting the PUSCH transmission based on the PUSCH configuration.

61. The method of claim 60, wherein the group common DCI dynamically schedules the PUSCH transmission for the aggressor UE.

62. The method of claim 60, wherein the group common DCI activates a configured grant for the aggressor UE and a corresponding semi-persistent scheduling (SPS) downlink (DL) configuration for the one or more victim UEs.

63. The method of claim 60, wherein the group common DCI activates a configured grant for the aggressor UE and a corresponding configuration of semi-persistent CSI-IM resources for the one or more victim UEs.

64. The method of claim 60, further comprising transmitting an indication that the aggressor UE supports the group common DCI for triggering configured grants in uplink.

65. An apparatus for wireless communication, comprising:
a processing system configured to perform the method of any of claims 1-32.

66. An apparatus for wireless communication, comprising:
means for performing the method of any of claims 1-32.

67. A non-transitory computer-readable medium storing computer executable code, the code when executed by a processor causes the processor to perform the method of any of claims 1-32.

68. An apparatus for wireless communication, comprising:
a processing system configured to perform the method of any of claims 33-59.

69. An apparatus for wireless communication, comprising:
means for performing the method of any of claims 33-59.

70. A non-transitory computer-readable medium storing computer executable code, the code when executed by a processor causes the processor to perform the method of any of claims 33-59.

71. An apparatus for wireless communication, comprising:
a processing system configured to perform the method of any of claims 59-64.

72. An apparatus for wireless communication, comprising:
means for performing the method of any of claims 59-64.

73. A non-transitory computer-readable medium storing computer executable code, the code when executed by a processor causes the processor to perform the method of any of claims 59-64.
